(19) United States
(12) Patent Application Publication
(10) Pub. No.: US 2019/0236137 A1
(43) Pub. Date: Aug. 1, 2019

(54) GENERATING CONVERSATIONAL REPRESENTATIONS OF WEB CONTENT

(71) Applicant: Microsoft Technology Licensing, LLC, Redmond, WA (US)

(72) Inventors: John Benjamin HESKETH, Kirkland, WA (US); Nikolai Michael FAALAND, Sammamish, WA (US)

(21) Appl. No.: 15/884,477

(22) Filed: Jan. 31, 2018

(51) Int. Cl. G06F 17/27; G06F 17/30

(52) U.S. Cl. CPC G06F 17/2785; G06N 99/005; G06F 17/30867; G06F 17/30899

(57) ABSTRACT

Contemporary human-computer interactions include conversational interactions, wherein devices present conversational prompts (e.g., generated speech) and conversational responses to user inquiries (e.g., verbal user input). Presented herein are techniques for automatically assembling conversational representations of web content. A variety of automated assembly techniques are disclosed, such as conversational template for websites of various website types. Interactions of users with a website may be monitored to identify actions that the users frequently perform, and conversational interactions may be generated that correspond to the actions. A web service may present a set of requests, and conversational interactions may be assembled to match the respective requests and responses of the web service. Conversational interactions may include transitions between websites, and conversational representations may be merged to integrate content from multiple websites. Action sets of actions and associated conversational representations may be compiled to provide a conversational interaction that aggregates the capabilities of many websites.

### BACKGROUND

Within the field of computing, many scenarios involve a presentation of web content. As a first example, a website is typically presented as a visual layout of content, such as a spatial arrangement of visual elements in various regions of a web page. The web page may permit interaction using various manual interfaces, such as pointer-based input via a mouse or touchpad; touch input via a touch-sensitive display; and/or text input via a keyboard. The visual layout of the website may include visual interaction elements such as clickable buttons; textboxes that may be selected to insert text input; scrollbars that scroll content along various dimensions; and hyperlinks that are clickable to navigate to a different web page. Many websites include dynamic visual content such as images and video that visually respond to user interaction, such as maps that respond to zoom-in gestures or scroll-wheel input by zooming in on a location indicated by a pointer. Text content is also presented according to a visual layout, such as a flow layout that wraps text around other visual content, and paragraphs or tables that fill a selected region and may respond to scroll input.

Websites also provide user interaction using various interfaces. As a first example, a website may present a visual layout of controls with which the user may interact to achieve a desired result, such as a web form that accepts user interaction in the form of text-entry fields, checkable checkboxes, and selectable radio buttons and list options, and a Submit button that submits the user input to a form processor for evaluation. Such interfaces may enable a variety of user interaction, such as placing a pizza delivery order from a restaurant by selecting toppings and entering a delivery address. As a second example, a website may provide a web service as a set of invokable requests. Users may initiate requests by providing data as a set of parameters that the website may receive for processing. Typically, the web service is invokable through a front-end application, such as a client-side app or web page, or a server-side script that invokes the web service on behalf of a user.

Additionally, within the field of computing, many scenarios involve conversational interactions between a device and a user. Such scenarios include, e.g., voice assistant devices; navigational devices provided in vehicles for primarily eyes-free interaction; and earpiece devices, such as headphones and earbuds. Conversational interaction is not necessarily limited to verbal communication; e.g., conversations may occur via the exchange of short messages such as SMS, and/or via accessibility modalities such as Braille and teletype. Conversations may also occur in hybrid models, such as verbal output by the device that is audible to the user and text responses that are manually entered by the user, and text prompts that are shown to a user who provides verbal responds.

In such scenarios, a device may be configured to receive user input in the form of a verbal command, such as “what is the time?”, and to respond by evaluating the user and providing a response, such as synthesized speech that states the current time. Such devices may be configured to perform a variety of tasks, such as reading incoming messages and email, accessing calendars, and initiating playback of music and audiobooks. Voice assistants may also accept verbal commands that are handled by other applications, such as a request to present a map to a destination, and may respond by invoking an application to fulfill the request, such as a mapping application that is invoked with the destination indicated by the user's verbal request.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Currently, the majority of web content is not designed for conversational presentation and interaction. For example, websites are uniformly designed for access via a visual web browser, and provide little or no functionality that enables a conversational interaction. Some websites provide a modest amount of information that may support accessibility applications, such as descriptive labels or tags for textboxes and images that a screen-reader application may use to provide a verbal description of the website. However, screen-reader applications may only be configured to provide a verbal narrative of the respective content elements of the website, which may provide a clumsy and inefficient user experience.

For example, a user may visit a website of a restaurant with the intention of ordering pizza. A verbal translation of the visual content of the website may include a great volume of information that is extraneous to the intent of the user, such as a list of addresses of restaurant locations and phone numbers; verbal descriptions of the images on the website (e.g., “a picture of a pizza . . . a picture of a stromboli . . . ”); and copyright notices. The user may encounter difficulty or frustration while mentally translating the narrative description of the visual layout into a cognitive understanding of the steps that the user can initiate to fulfill the intent of ordering a pizza through the website, particularly if the content that is useful for this task—such as a list of available toppings, prices, and a telephone number—are commingled with the extraneous information. Moreover, the website may feature robust visual interfaces for performing such tasks, such as web forms or interactive applications that allow users to place orders, which a screen-reader application may be incapable of presenting in narrative form based on a per-element verbal description.

In some instances, a web developer may endeavor to create a conversational representation of web content. For example, a developer of an information source, such as an encyclopedia, may provide a traditional website with a visual layout, and also a conversational interface that receives a verbal request for content about a particular topic and delivers a synthesized-speech version of the encyclopedic content about the topic. However, in many such instances, the effort of the developer to provide a conversational representation of the web content may be disjointed from the effort to provide the traditional website layout. For example, the web developer may add features to the visually oriented website, such as a text-editing interface for submitting new content and editing existing content, and/or a text chat interface or forum that enables visitors to discuss topics. However, the developer must expend additional effort adding the features to the conversational interaction. In some cases, the corresponding conversational feature may be difficult to develop. In other cases, the corresponding conversational interaction may differ from the visual interface (e.g., the text-editing interface may add formatting features that are not available in the conversational interaction unless and until the developer adds them). When development efforts are discrete and disjointed, changes to one interface may break the other interface—e.g., modifications to the functionality of a traditional website feature may cause the corresponding functionality in the conversational interaction to stop working.

The present disclosure provides techniques for automatically generating conversational representations of web content, such as websites and web services. For example, when a user visits the website for a pizza delivery restaurant, instead of presenting an exhaustive narration of the visual content of a restaurant, a device may narratively describe the types of food that the website features: pizza, stromboli, salad, etc. If the user specifies an interest in ordering pizza, the device may provide a conversational process that solicits information about the user's desired toppings, and may invoke various actions through the website or web service that translate the user's responses into the corresponding actions. In such manner, the device may use a conversational representation of the web content to provide a conversational interaction between the user and the web content.

The automated techniques presented herein involve an automated gathering of web content elements, such as the contents of a website; the automated assembly of a conversational representation, such as a dialogue-based interaction in which the web content is accessible through conversational prompts, queries, and responses; and the presentation of the web content to the user in a conversational format, such as providing conversational prompts that briefly describe available actions of the website or web service, and translating the user's conversational responses into content navigation and action invocation.

The present disclosure provides a variety of techniques for automatically performing each element of this process. As a first example, a device may identify a website as a particular website type, either based on semantic metadata and/or by recognizing and classifying the content of the website as similar to other websites of a particular website type (e.g., recognizing that a website featuring words such as “pepperoni,” “deep-dish,” and “delivery” closely resembles a pizza delivery website). The content elements of the website may be fit into a conversational template for websites of the website type. As a second example, interactions of users with a website may be monitored to identify actions that the users frequently perform—e.g., automatically identifying that some website visitors place a specific series of actions to order a pizza via a web form, while other visitors search for a phone number and then initiate a call to place a pizza delivery order. Conversational interactions may be generated that correspond to the actions of the users (e.g.: “would you like to order a pizza, or would you prefer to call the restaurant directly?”) As a third example, a web service may present a set of requests, and conversational interactions may be selected to match the respective requests and responses of the web service (e.g., a RESTful web service may provide a number of invokable methods, and conversational interactions may be generated that initiate RESTful requests based on user input). Many such techniques may be used to generate and present conversational representations of web content in accordance with the techniques presented herein.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an example scenario featuring various techniques for presenting a website to a user.

FIG. 2 is an illustration of an example scenario featuring a presentation of a website to a user as a conversational representation.

FIG. 3 is an illustration of a first example method of presenting a conversational representation of a website to a user in accordance with the techniques presented herein.

FIG. 4 is an illustration of a second example method of presenting a conversational representation of a website to a user in accordance with the techniques presented herein.

FIG. 5 is an illustration of an example device that presents a conversational representation of a website to a user in accordance with the techniques presented herein.

FIG. 6 is an illustration of an example computer-readable storage device that enables a device to present an application within a virtual environment in accordance with the techniques presented herein.

FIG. 7 is an illustration of example scenarios featuring example devices and architectures in which the techniques presented herein may be utilized.

FIG. 8 is an illustration of an example scenario featuring a conversational representation of a website that reflects a structure of the website in accordance with the techniques presented herein.

FIG. 9 is an illustration of an example scenario featuring a conversational representation of a website that reflects a set of actions that are performed by users through the website in accordance with the techniques presented herein.

FIG. 10 is an illustration of an example scenario featuring conversational representations that are structured around user interaction styles in accordance with the techniques presented herein.

FIG. 11 is an illustration of an example scenario featuring conversational representations that are structured around user contexts in accordance with the techniques presented herein.

FIG. 12 is an illustration of an example scenario featuring a selective supplementation of a conversational representation of a website with visual content in accordance with the techniques presented herein.

FIG. 13 is an illustration of an example scenario featuring a conversational representation of a web service in accordance with the techniques presented herein.

FIG. 14 is an illustration of an example scenario featuring a conversational representation of a website using a set of conversational representation templates that respectively correspond to website types in accordance with the techniques presented herein.

FIG. 15 is an illustration of a first example scenario featuring a transition between a first conversational representation of a first website and a second conversational representation of a second website in accordance with the techniques presented herein.

FIG. 16 is an illustration of a second example scenario featuring a transition between a first conversational representation of a first website and a second conversational representation of a second website in accordance with the techniques presented herein.

FIG. 17 is an illustration of an example scenario featuring a merging of conversational representations of respective websites in accordance with the techniques presented herein.

FIG. 18 is an illustration of an example scenario featuring an action set of actions and conversational representations thereof that have been assembled from a collection of websites in accordance with the techniques presented herein.

FIG. 19 is an illustration of an example scenario featuring an action selection of an action from an action set of actions and an invocation of a conversational representation therewith in accordance with the techniques presented herein.

FIG. 20 is an illustration of an example scenario featuring a workflow assembled from a collection of actions and the presentational conversations therefor in accordance with the techniques presented herein.

FIG. 21 is an illustration of an example scenario featuring a development of a conversational representation according to a training model in accordance with the techniques presented herein.

FIG. 22 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

### A. Introduction

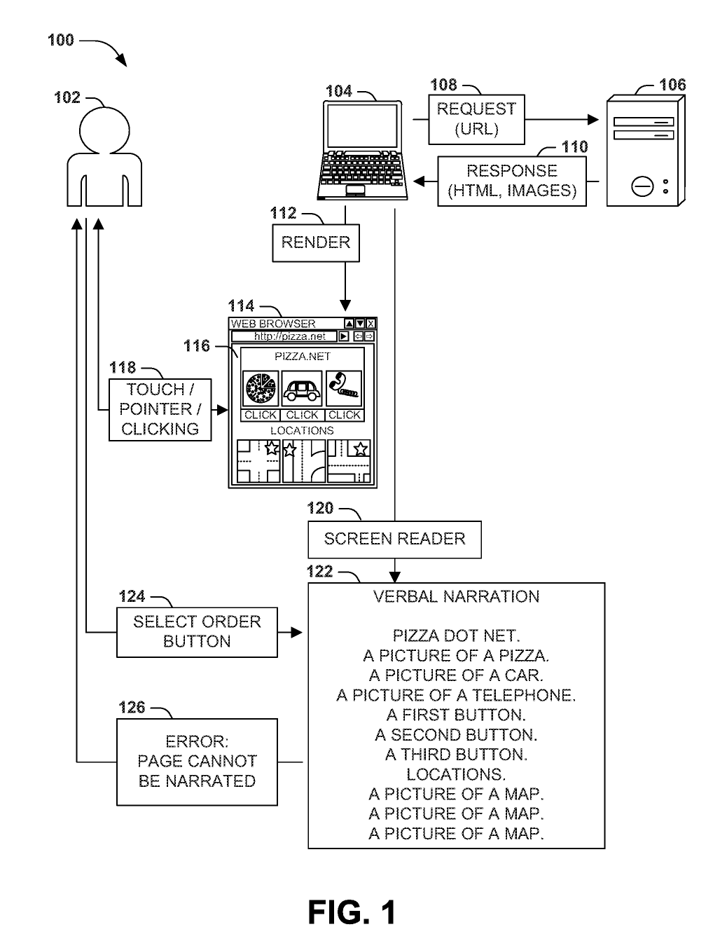

FIG. 1 is an illustration of an example scenario 100 featuring some ways in which a website 116 may be presented to a user 102 of a device 104.

In this example scenario 100, a user 102 may initiate a request 108 to a device 104 for a presentation of a particular website 116, such as by providing the uniform resource locator (URL) or address of a requested web page. The device 104 may forward the request 108 to a webserver 106, which may provide a response 110 that includes the requested web content, such as a Hypertext Markup Language (HTML) document that encodes declarative statements that describe the structure and layout of the web page, scripts in languages such as JavaScript that add functionality to the web page, and content elements to be positioned according to the layout, such as text, images, videos, applets, and hyperlinks to other websites 116. The device 104 of the user 102 may render 112 the HTML document and embedded content, and may present, within a web browser 114, a visual layout of the website 116, where the content elements are spatially arranged as specified by the HTML structure. For example, text may be positioned within a region that is wrapped around other content elements, such as a flow layout, or in a scrollable region that is scrollable through manipulation of a scrollbar or mouse wheel. Images may be positioned by selecting a location according to various formatting instructions (e.g., horizontal and/or vertical centering, and/or anchoring with respect to another element) and scaled to fit a specified size or aspect ratio. Data may be arranged in tables; buttons may be arranged into visual menus or groups, such as collections of radio buttons; and textboxes may be arranged as the elements of a fillable form. Other visual areas of the website 116 may enable more dynamic user interaction, such as a map that provides an image of a location, and that responds to zoom-in and zoom-out operations by re-rendering the map at a different zoom level. The user 102 may interact with the content elements of the website 116 through user input 118, such as selecting elements with a pointer by manipulating a mouse or touchpad, or by touching such elements on a device featuring a touch-sensitive display.

In many such scenarios, it may be desirable to present the content elements of the website 104 not according to a visual layout, but in a different manner. As a first such example, a visually impaired user 102 may wish to interact with the website 116 through an accessibility application, such as a screen reader 120 that verbally describes the content of the website 116 and that endeavors to enable user input 118 that does not depend upon a visual layout, such as vocal commands from the user 102 or keyboard input that may be translated into the selection of various content elements. As a second such example, a user 102 may choose to interact with the website 116 in a context in which visual output is difficult or even dangerous, and/or in which user input 118 that depends upon a visual layout is problematic, such as while the user 102 is such as while the user 102 is walking, exercising, or navigating a vehicle. In such scenarios, the user 102 may prefer an “eyes-free” interaction in which the content elements of the website 116 are presented audially rather than as a visual layout. As a third such example, a user 102 may prefer a different type of interaction with the website 116 than the typical visual layout and user input 118 that depends upon such visual layout, such as interacting with the website 116 via a text-only interface such as text messaging or email.

In view of such scenarios, some devices 104 may provide alternative mechanisms for enabling interaction between the user 102 and the website 116. For example, a screen reader 120 may generate a verbal narration 122 of website 116 by retrieving the HTML document and embedded content from the webserver 106, and then providing a verbal narration 122 of the respective content elements. For example, the screen reader 120 may read the text embedded in the website 116, and then enumerate and describe each of a set of buttons that is presented in the website 116. The screen reader 120 may also listen for verbal commands from the user 102 that specify some forms of interaction with the website 116, such as “read,” “stop,” “faster,” “slower,” “re-read,” and “select first button” to initiate a click event upon a selected button. Some websites 116 may facilitate interaction by applications such as screen readers 120 by including semantic metadata that describes some visual content items. For example, images may include a caption that describes the content of the image, and the screen reader 120 may read the caption to the user 102 to present the content of the image. Alternatively, the screen reader 120 may utilize an image recognition algorithm or service to evaluate the contents of an image and to present a narrative description of depicted people and objects. Additionally, the screen reader 120 may accept verbal commands 124 form the user 102, such as a request to select the second button that is associated with a pizza delivery order, may initiate requests 108 to the webserver 106 corresponding to such actions, and may endeavor to narrate the content presented by the webserver 106 in response to such actions.

For some websites 116, a verbal narration 122 may be adequate to enable an interaction between the user 102 and the website 116. However, for many websites 116, the use of a screen reader 120 may be problematic for a variety of reasons.

In the example scenario 100 of FIG. 1, the website 116 comprises a restaurant that delivers pizza. The website 116 includes a set of images that convey various aspects of the restaurant, such as an image of the food offered by the restaurant; an image of a delivery vehicle; and an image of a phone that suggests calling the restaurant to place an order. The respective images may be linked to and/or positioned near hyperlinks and/or buttons, e.g., to connote the functions of the buttons (the first button shows a menu; the second button initiates a delivery order; and the third button displays the phone number of the restaurant). The website may also present a set of locations as a collection of maps that respectively depict the images, optionally with the address embedded as a rendered font.

While this website 116 may be relatively straightforward and easy to use in a visual context, a verbal narration 122 of the website 116 may be problematic. As a first example, the website may indicate the contents of the images (either by reading semantic metadata or by recognizing the contents of the images) as: “a picture of food, a picture of a car, and a picture of a telephone.” This narration may be unhelpful and even confusing—e.g., “a picture of a car” may not accurately describe the car as a delivery vehicle that connotes pizza delivery, and the user 102 may not readily understand its significance. As a second example, the layout of the website 116 lead to a confusing verbal narration 122. For example, if the buttons are positioned below the images and the screen reader 120 narrates the website 116 in horizontal left-to-right order, the spatial connection may be lost, such that “a first button, a second button, and a third button” may be difficult to correlate with the functions presented in the images directly above them. As a third example, the description of the maps as “a picture of a map” may fail to relay the significant content of the map—i.e., the actual locations of the restaurants—and may therefore be unusable by the user 102. As a fourth example, the user 102 may initiate a verbal command 124 such as a selection of a button that initiates a pizza delivery order, but the webserver 106 may respond by providing content for which a verbal narration 122 is not feasible, such as a JavaScript application that allows the user 102 to design a pizza using a variety of active controls for which corresponding verbal narration 122 is unavailable. The screen reader 120 may present a variety of unusable descriptions, such as enumerating the buttons and numeric controls on a web form, or may respond by reporting an error 126 indicating that a verbal narration 122 is not possible.

In addition to the difficulties depicted in the example scenario 100 of FIG. 1, other problems may arise with the verbal narration 122 of the content of a website 116. As a first example, a screen reader 120 may have difficulty distinguishing between content elements that the user 102 wishes to have described—i.e., those that relate to the intent of the user 102 in visiting the website 116—and content elements that the user 102 does not care to have described. As a first example, some websites 116 may present content-heavy web pages that are loaded with extraneous information, such as advertisements, hyperlinks to affiliated sites, and copyright notices. The screen reader 120 may be unable to filter out the undesired elements of the content-heavy website, and may simply narrate all of the content for the user 102, who may have difficulty identifying the content elements that the user 102 wishes to utilize, or even understanding the functionality that the website 116 provides. As a second example, a user 102 visiting a restaurant website 116 may wish to visit the nearest location, but the website 116 may include an exhaustive list of all restaurant locations, including distant locations in other states or nations. The screen reader 120 may therefore begin reading a voluminous list of hundreds of street addresses to the user 102, of which only one may be relevant to the intent of the user 102.

It may be appreciated that these and other problems may arise from a simple verbal narration 122 of the content elements of the website 116. In particular, a user 102 may wish to interact with a website 116 not by viewing or otherwise consuming the visual layout of the content elements, but rather according to the intent of the user 102 in visiting the website 116. That is, the user 102 may seek a particular kind of interaction, such as examining the menu, ordering delivery, calling the restaurant, and finding a location in order to drive to the restaurant using a navigational device. While the website 116 may enable these tasks for users 102 who view and interact with the website 116 according to its visual layout, the verbal narration 122 may hinder such interactions. Instead, it may be desirable to present a representation of the website 116 that is oriented as a series of interactions that reflect the intent of the user 102 when visiting the website 116. Such interactions may be structured as conversations in which the device receives a conversational inquiry from the user and responds with a conversational response. The sequence of conversational inquiries and responses may be structured to determine the intent of the user 102, such as the types of content that the user 102 seeks from the website 116 and/or the set of tasks or actions that the user 102 intends to fulfill while visiting the website 116. The sequence of interactions comprising the conversation may be oriented to the identified content request or intended task, such as prompting the user 102 to provide relevant information (e.g., the details of an order placed at a restaurant), and may inform the user of the progress and completion of the task. Moreover, the types of interaction may be adapted to the type of task. For example, if the intent of the user 102 is a presentation of information in which the user 102 is comparatively passive, the conversation presented by the device may be structured as a narrative interaction, such as reading the content of an article with opportunities for the user to control the narrative presentation. If the intent of the user 102 is to query the website for a particular type of content, the conversation may involve filtering the available content items and prompting the user to provide criteria that may serve as a filter. If the intent of the user 102 is actively browsing the content of the website 116 or navigating among the available areas, the conversation may be structured as a dialogue, with brief descriptions of the content in a current location and the options for navigating to related areas. Many such forms of interaction may enable the user 102 to access the content of the website 116 in a more conversational manner rather than according to its visual layout.

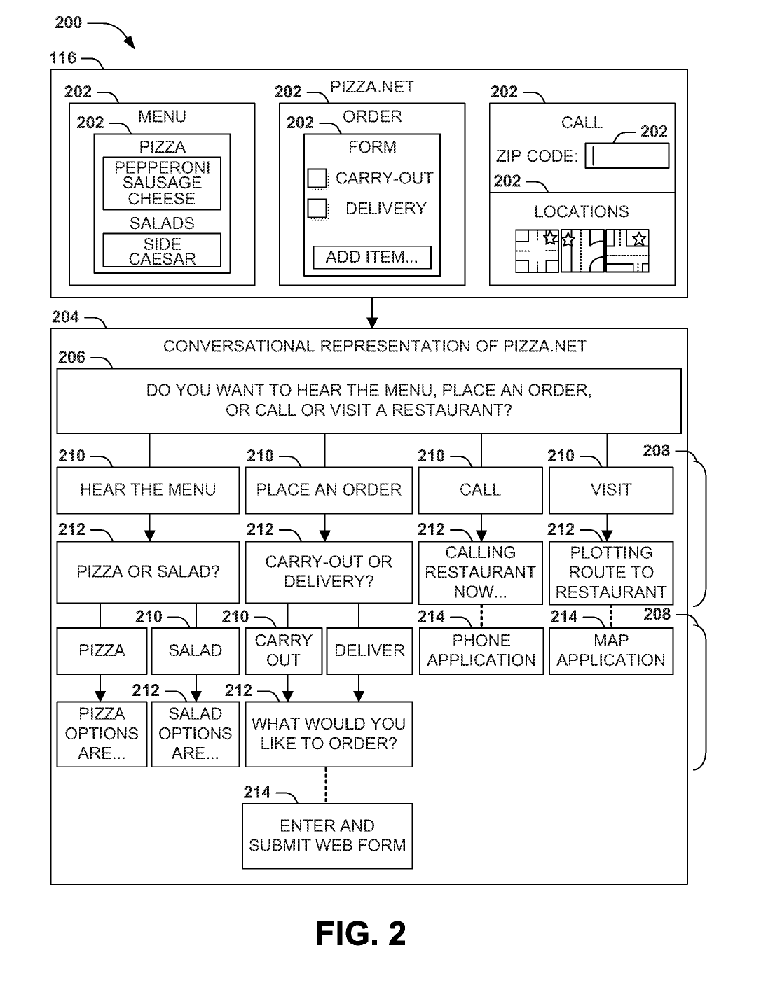

FIG. 2 is an illustration of an example scenario 200 featuring a conversational representation of the website 116 introduced in the example scenario 100 of FIG. 1. In the example scenario 200 of FIG. 2, the website 116 comprises a visual layout of content elements 202 organized as discrete areas that pertain to different areas, such as a menu indicating the options for food; an order form for food delivery; a search interface to call a restaurant that is closest to a location specified as a zip code; and a set of locations of restaurants that are identified as maps. A user 102 may interact with the website 116 according to its visual layout, but may, in some circumstances, prefer to interact with the website 116 in a conversational manner. Accordingly, a conversational representation 204 of the website 116 may be assembled that first presents a conversational prompt 206 indicating the actions that are available for the website 116, such as examining the menu; placing an order; and calling or visiting a restaurant location. The actions in this conversation correspond to various subsets of the content elements 202 of the website 116, such as the content elements 202 that are semantically related and/or grouped together on a particular web page or page region. The conversational representation 204 may include a set of conversation pairs 208 comprising a conversational inquiry 210 presented by the user 102 (e.g., spoken or typed text that corresponds to one of the actions), and a conversational response 212 that advances the conversational interaction, such as by presenting requested information or soliciting additional information that advances the task or action that the user 102 intends to perform. At some points in the conversation, the conversational representation 204 may indicate certain actions 214 that the device may perform on behalf of the user 102, such as entering data received from the user 102 (as conversational inquiries 210) into a fillable form of the website 116 that, when submitted, initiates, advances, and/or completes a task as the user 102 intended.

An organization of such conversational pairs 208 may provide some advantages. As one such example, the organization may enable the conversational representation 204 to cover the content of the website 116 in a focused manner (e.g., while engaging in a conversation with the intent of placing an order for delivery, the user 102 may not be presented with information about the addresses of the locations, which may not be relevant to the task of ordering delivery). Such an organization may be particularly significant for websites 116 that present a broad variety of content and actions, as the user may otherwise be overwhelmed by the range of available options and details. As another example, a conversational representation 204 of the website 116 may be presented to the user 102 in various ways, such as a verbal interaction between the user 102 and a device; a text-based conversation, such as an exchange of text messages in a conversational manner; and/or a hybrid, such as gestures or text entered by the user 102 as conversational inquiries 210 followed by spoken conversational responses 212 that convey a result of the conversational inquiry 210.

Because conversational representations 204 may provide an appealing alternative to interactions according to visual layout, a developer may endeavor to create a conversational representation 204 for use by a device 104 of the user 102. As an example, a developer may write a dialogue script of conversation pairs 208, and may indicate the actions to be invoked through the website 116 at certain points in the conversation. The conversational representation 204 may be implemented in an application, such as a mobile app, and/or may be offered as an alternative to a visual layout, thus presenting the user 102 with several options for interacting with the website 116. Additionally, when the user 102 visits the website 116, the device 104 of the user 102 may detect the availability of the conversational representation 204 (e.g., based on a reference in an HTML document that provides the URL of the conversational representation 204), and may choose to retrieve and present the conversational representation 204 instead of and/or supplemental to the visual layout of the website 116.

However, the capabilities of developers to provide, test, and maintain a conversational interaction may be limited in various ways.

As a first example, a developer may not have the time, familiarity, expertise, and/or interest to develop an adequate conversational representation 204 of a website 116. For example, the overwhelming majority of current web content is available only as a visual layout, or in a format that may support a verbal narration 122 but not particularly as a conversational interaction. For example, many websites 116 include a real simple syndication (RSS) feed that presents selected excerpts of web content, but in many cases, such syndication is intended to provide only a “teaser” that encourages the user 102 to visit the website 116 in its visual layout representation. While such syndication may support some form of verbal narration 122, such narration is unlikely to support a conversational interaction, and may be subject to many of the limitations exhibited by the example scenario 100 of FIG. 1. Moreover, many websites include content presented in a visual layout that will never support a conversational interaction because the content is not actively maintained by a developer who is both sufficiently capable and motivated to assemble a conversational representation 204.

As a second example, a developer may prepare a conversational representation 204 of the website 116, but the content and/or functionality of the conversational representation 204 may differ from the content and/or functionality of the visual layout. For instance, features that are available in the visual layout of the website 116 may be unavailable in the conversational representation 204, and such discrepancies may be frustrating to users 102 who expect or are advised of the availability of content or functionality that is not present or different in a selected format. Moreover, such discrepancies may be exacerbated over time; e.g., continued development of the visual layout after the developer's preparation of the conversational representation 204, such as content or functionality additions that are inadvertently included only in the visual layout presentation of the website 116, may cause the presentations to diverge.

As a third such example, changes in the visual layout may break some functionality in the conversational representation 204, such as where resources are moved or relocated in ways that are reflected in the visual layout, but such updates may be unintentionally omitted from the conversational representation 204 and may produce errors or non-working features.

As a fourth example, even where the developer diligently develops and maintains the conversational representation 204 in synchrony with the visual layout, such development may be inefficient, redundant, and/or tedious for the developer, which may divert attention and resources from the development of new content and/or features. These and other problems may arise from developer-driven generation of a conversational representation 204 of a website 116.

### B. Presented Techniques

The present disclosure provides techniques for an automated assembly of a conversational representation of web content of a website 116. In general, the techniques involves evaluating the website 116 to identify a set of content elements, such as the visual layout of one or more web pages, and/or a set of invokable methods presented as one or more web services. The techniques then involve assembling the content elements into a conversational representation 204 of the website 116, wherein the conversational representation 204 comprises an organization of conversation pairs 208 respectively comprising a conversational inquiry 210 and a conversational response 212 to the conversational inquiry 210 that involves at least one of the content elements of the website 116. The conversational representation 204 may be automatically assembled in a variety of ways that are discussed in detail herein, such as (e.g.) by retrieving an index of the website 116 and modeling conversations that cover the resources of the index; using a conversational templates that is suitable for the type and/or sematic content of the website 116; by monitoring user interactions with the website 116, and generating conversations and conversation pairs that reflect the user interactions that users most frequently choose to conduct on the website 116; and/or developing learning models that are trained using prototypical user-generated conversational representations 204 of websites 116 and that are capable of generating similar conversational representations 204 for new websites 116. The techniques also involve using the automatically assembled conversational representation 204 to enable a user 102 to access the website 116, such as by receiving a conversational inquiry 210 from the user 102 and presenting a conversational response 212 for a conversation pair 208 including the conversational inquiry 210, and/or by transmitting at least a portion of the conversational representation 204 to a device (such as a device 104 of the user 102, or to a webserver 106 for the website 116) for subsequent presentation to the user 102 as a conversational interaction. The use of such techniques as discussed in greater detail herein may enable the automated assembly of a conversational representation 204 and the use thereof to enable conversational interactions between the website 116 and users 102.

### C. Technical Effects

The use of the techniques presented herein in the field of presenting web content may provide a variety of technical effects.

A first technical effect that may be achievable through the use of the techniques presented herein involves the assembly of a conversational representation 204 of the content of a website 116. The conversational representation 204 of the website 116 may enable a variety of interactions that are not available, or not as satisfactory, as either a visual layout or a verbal narration 122 thereof. Such interactions include the presentation of the website 116 to visually impaired users 102 who are unable to view or interact with the visual layout, and users 102 who are contextually unable to view or interact with the visual layout in a convenient and safe manner, such as users 102 who are walking, exercising, or operating a vehicle.

A second technical effect that may be achievable through the use of the techniques presented herein involves the presentation of a website 116 to a user 102 as a more efficient and/or convenient user experience than a visual layout or verbal narration 122 thereof. For some types of websites 116, such as content-heavy websites and/or poorly organized websites, the content and/or actions that the user 102 wishes to access are difficult to identify amid the volume of extraneous content. A conversational representation 204 of a website 116 may provide interactions that are based upon the content, actions, and tasks that the user 102 wishes to access and/or perform, which may differ from the structure of the website 116 that may be based upon other considerations, and which may therefore enable users to achieve such results in a more direct, efficient, and intuitive manner. As yet another example, the assembly of a conversational representation 204 may enable user interactions with web content that may not otherwise be accessible to users 102, such as web services that communicate via an interface format, such as JavaScript Object Notation (JSON) or Extensible Markup Language (XML) documents. The presentation of a conversational representation 204 may solicit information from the user 102 that matches the parameters of web service queries, and that invoke such methods on behalf of the user 102, even if a convenient user-oriented interface is not available. Such interactions may be preferable to some users 102, such as individuals who are unfamiliar with websites 116 or the particular website 116, for whom conversational interactions may present a more familiar and intuitive interaction modality.

A third technical effect that may be achievable through the use of the techniques presented herein involves the automation of the process of assembling the conversational representation 204 of the website 116. As a first such example, a great volume of currently available web content is not actively maintained by a developer who is sufficiently capable and motivated to assemble a conversational representation 204, and the techniques presented herein to achieve an automated assembly of a conversational representation 204 may enable the technical advantages of such a conversational representation 204 that would otherwise be unavailable. As a second example, an automated representation of the conversational representation 204 may provide more comprehensive and/or complete representation of the website 116, including greater consistency with the traditional visual layout representation, than a conversational representation 204 that is manually developed by a developer. For instance, if the conversational representation 204 is based upon automated monitoring of user interactions with the visual layout of the website 116, the automatically assembled conversational representation 204 may exhibit a more faithful and convenient reflection of users' intent than one developed by a developer that is based on the developers inaccurate and/or incomplete understanding of user intent. As a third example, the automatically assembled conversational representation 204 may be automatically re-assembled or updated as the content of the visual layout representation changes, thus promoting synchrony that is not dependent upon the diligence of the developer. As a fourth example, even where a developer-generated conversational representation 204 is both achievable and comparable with an automatically assembled conversational representation 204, the automation of the assembly may enable the developer to devote attention to other aspects of the website 116, such as creating new content and adding or extending website functionality. Many such technical effects may be achievable through the use of techniques for the automated assembly of conversational representations 204 of web content in accordance with the techniques presented herein.

### D. Example Embodiments

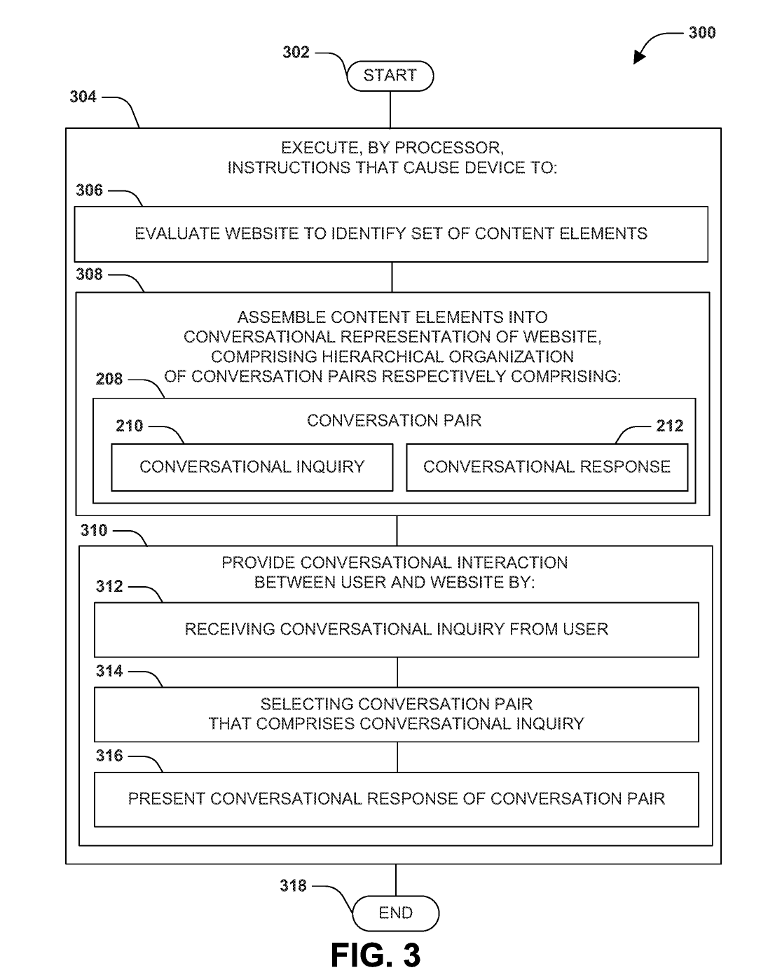

FIG. 3 is an illustration of an example scenario featuring an example embodiment of the techniques presented herein, wherein the example embodiment comprises a first example method 400 of presenting a conversational representation 204 of a website 116 to a user 102 in accordance with techniques presented herein. The example method 300 involves a device comprising a processor, and may be implemented, e.g., as a set of instructions stored in a memory of the device, such as firmware, system memory, a hard disk drive, a solid-state storage component, or a magnetic or optical medium, wherein the execution of the instructions by the processor causes the device to operate in accordance with the techniques presented herein.

The example method 300 begins at 302 and involves executing, by the processor, instructions that cause the device to operate in accordance with the techniques presented herein. In particular, the instructions cause the device to evaluate 306 the website 116 to identify a set of content elements. The instructions also cause the device to assemble 308 the content elements into a conversational representation 204 of the website 116, wherein the conversational representation 204 comprises an organization of conversation pairs 208 respectively comprising a conversational inquiry 210 and a conversational response 212 to the conversational inquiry 210 that involves at least one of the content elements of the website 116. The instructions also cause the device to provide 310 a conversational interaction between the user 102 and the website 116 by receiving 312 a conversational inquiry 210 from the user 102; selecting 314 the conversation pair 208 in the conversational representation 204 that comprises the conversational inquiry 210; and presenting 316 the conversational response 212 of the conversation pair 208 to the user 102. In such manner, the example method 300 causes the device to present the website 116 to the user 102 as a conversational representation 204 in accordance with the techniques presented herein, and so ends at 318.

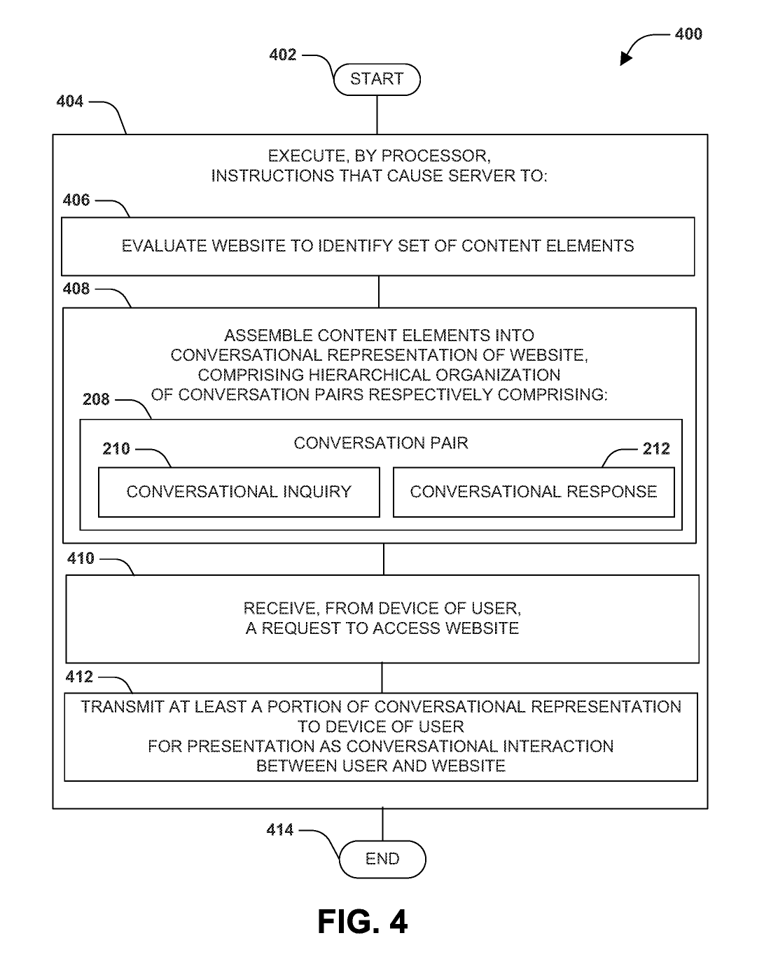

FIG. 4 is an illustration of another example scenario featuring an example embodiment of the techniques presented herein, wherein the example embodiment comprises a second example method 400 of presenting a conversational representation 204 of a website 116 to a user 102 in accordance with techniques presented herein. The example method 400 involves a server comprising a processor, and may be implemented, e.g., as a set of instructions stored in a memory of the server, such as firmware, system memory, a hard disk drive, a solid-state storage component, or a magnetic or optical medium, wherein the execution of the instructions by the processor causes the device to operate in accordance with the techniques presented herein.

The example method 400 begins at 402 and involves executing, by the processor, instructions that cause the server to operate in accordance with the techniques presented herein. In particular, the instructions cause the server to evaluate 406 the website 116 to identify a set of content elements. The instructions also cause the server to assemble 408 the content elements into a conversational representation 204 of the website 116, wherein the conversational representation 204 comprises an organization of conversation pairs 208 respectively comprising a conversational inquiry 210 and a conversational response 212 to the conversational inquiry 210 that involves at least one of the content elements of the website 116. The instructions also cause the server to receive 410, from a device 104 of the user 102, a request to access the website 116. The instructions also cause the server to transmit 412 at least a portion of the conversational representation 402 of the website 116 to the device 104 of the user 102 for presentation as a conversational interaction between the user 102 and the website 116. In such manner, the example method 400 causes the device to present the website 116 to the user 102 as a conversational representation 204 in accordance with the techniques presented herein, and so ends at 414.

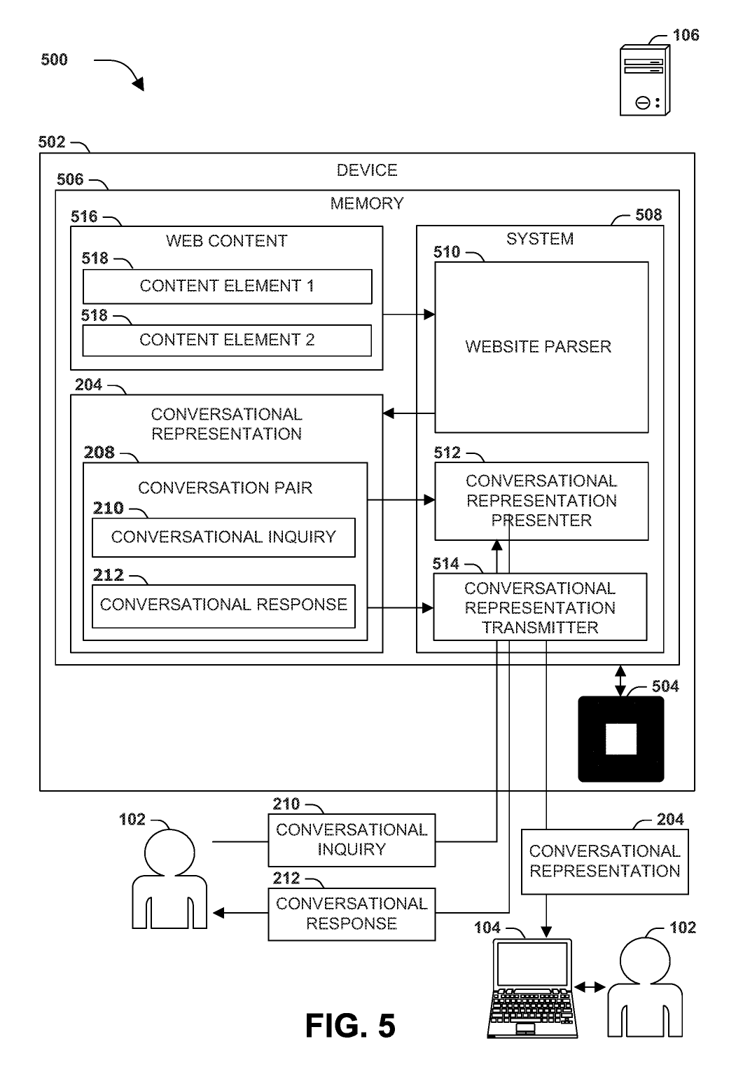

FIG. 5 is an illustration of an example scenario 500 featuring a third example embodiment of the techniques presented herein, illustrated as an example device 502 that presents a website 116 to users 102 in accordance with the techniques presented herein. The example device 502 comprises a memory 506 (e.g., a memory circuit, a platter of a hard disk drive, a solid-state storage device, or a magnetic or optical disc) encoding instructions that are executed by a processor 504 of the example device 502, and therefore cause the device 502 to operate in accordance with the techniques presented herein. In particular, the instructions encode an example system 508 of components that interoperate in accordance with the techniques presented herein. The example system comprises a website parser 510 that evaluates the web content 516 provided by the webserver 106 for the website 116 to identify a set of content elements 518, such as content items like text or images; structural elements such as web pages, tabs, tables, and divisions; embedded data sets, such as content indices, encoded in formats such as XML or JSON; embedded scripts such as JavaScript; navigational references such as hyperlinks; interactive elements such as user interface controls, web forms, and interactive applets; and/or collections of one or more invokable methods, such as web services. The website parser 510 assembles the content elements 518 into a conversational representation 204 of the website 208, wherein the conversational representation 204 comprises an organization of conversation pairs 208 respectively comprising a conversational inquiry 210 and a conversational response 212 to the conversational inquiry 210 that involves at least one of the content elements 518 of the website 116. The example system 508 of the example device 502 also provide a conversational interaction between the user 102 and the website 116. As a first such example, the example system 508 may comprise a conversational representation presenter 512, which receives a conversational inquiry 210 from a first user 102; selects the conversation pair 208 in the conversational representation 204 that comprises the conversational inquiry 210; and presents the conversational response 212 of the conversation pair 208 to the user 102. As a second such example, the example system 508 may comprise a conversational representation transmitter 514, which receives a request from a device 104 of a second user 102 to access the website 116, and transmits at least a portion of the conversational representation 204 to the device 104 of the second user 102 for presentation to the second user 102 as a conversational interaction between the second user 102 and the website 116. As a third such example (not shown), the conversational representation transmitter 514 may transmit at least a portion of the conversational representation 204 to the webserver 106 for storage thereby and presentation to users 102 as a conversational interaction with the website 116. In such manner, the example device 502 may utilize a variety of techniques to enable conversational interactions between the website 116 and various users 102 in accordance with the techniques presented herein.

Still another embodiment involves a computer-readable medium comprising processor-executable instructions configured to apply the techniques presented herein. Such computer-readable media may include various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein. Such computer-readable media may also include (as a class of technologies that excludes communications media) computer-computer-readable memory devices, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein.

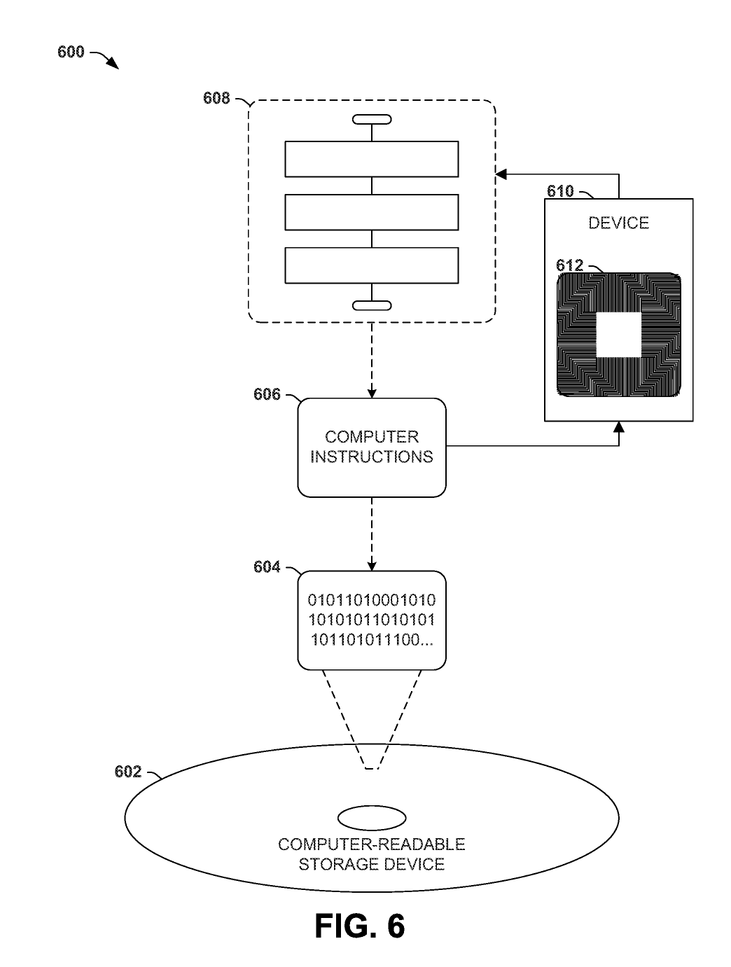

An example computer-readable medium that may be devised in these ways is illustrated in FIG. 6, wherein the implementation 600 comprises a computer-readable memory device 602 (e.g., a CD-R, DVD-R, or a platter of a hard disk drive), on which is encoded computer-readable data 604. This computer-readable data 604 in turn comprises a set of computer instructions 606 that, when executed on a processor 612 of a device 610, cause the device 610 to operate according to the principles set forth herein. For example, the processor-executable instructions 606 may encode a method that presents a website 116 to one or more users 102, such as the first example method 300 of FIG. 3 and/or the second example method 400 of FIG. 4. As another example, execution of the processor-executable instructions 606 may cause a device to embody a system for presenting a website 116 to a user 102, such as the example device 502 and/or the example system 508 of FIG. 5. Many such computer-readable media may be devised by those of ordinary skill in the art that are configured to operate in accordance with the techniques presented herein.

### E. Variations

The techniques discussed herein may be devised with variations in many aspects, and some variations may present additional advantages and/or reduce disadvantages with respect to other variations of these and other techniques. Moreover, some variations may be implemented in combination, and some combinations may feature additional advantages and/or reduced disadvantages through synergistic cooperation. The variations may be incorporated in various embodiments (e.g., the first example method of FIG. 3; the second example method of FIG. 4; and the example device 502 and/or example method 508 of FIG. 5) to confer individual and/or synergistic advantages upon such embodiments.

E1. Scenarios

A first aspect that may vary among embodiments of these techniques relates to the scenarios wherein such techniques may be utilized.

As a first variation of this first aspect, the techniques presented herein may be utilized on a variety of devices, such as servers, workstations, laptops, consoles, tablets, phones, portable media and/or game players, embedded systems, appliances, vehicles, and wearable devices. Such devices may also include collections of devices, such as a distributed server farm that provides a plurality of servers, possibly in geographically distributed regions, that interoperate to present websites 116 to users 102. Such devices may also service a variety of users 102, such as administrators, guests, customers, clients, and other applications and/or devices, who may utilize a variety of devices 104 to access the website 116 via a conversational interaction, such as servers, workstations, laptops, consoles, tablets, phones, portable media and/or game players, embedded systems, appliances, vehicles, and wearable devices. Such techniques may also be used to present a variety of websites 116 and web content to users 102, such as content such as text, images, sound, and video, including social media; social networking; information sources such as news and encyclopedic references; interactive applications such as navigation and games; search services for generalized search (e.g., web searches) and selective searches over particular collections of data or content; content aggregators and recommendation services; and websites related to commerce, such as online shopping and restaurants. Such websites may also be presented as a traditional visual layout for a desktop or mobile website; via a specialized app for selected devices; as a verbal narration 122; and/or as a web service that presents a collection of invokable functions.

As a second variation of this first aspect, the techniques presented herein may enable the presentation of the website 116 to the user 102 in a conversational interaction in a variety of circumstances. As a first such example, the conversational interaction may occur between a visually impaired user 102 and a website 116, in which the user 102 may utilize a screen reader 120 to narrate the content of the website 116. The presentation of the conversational interaction may provide significant advantages as compared with the verbal narration 122 of the respective content elements 518 as discussed herein. As a second such example, the conversational interaction may be presented to a user 102 who is contextually unable to utilize a visual layout in a convenient and/or safe manner, such as a user 102 who is walking, exercising, or navigating a vehicle. As a third such example, the conversational interaction may be presented to a user 102 who is contextually unable to interact with the website 116 via user input 118 that is based on a visual layout, such as mouse, touchpad, and/or touch-sensitive input, where the user 102 instead utilizes other forms of user input, such as text messaging or verbal communication. As a fourth such example, the conversational interaction may be presented to a user 102 who prefers an alternative interaction mechanism to a visual layout, such as a user 102 who wishes to access a particular type of content and/or perform a particular task, and for whom achieving these results using a content-heavy visual layout of the website 116 may be less convenient than conversational interactions that are oriented around the intent of the user 102. Such users 102 may include individuals who are unfamiliar with websites 116 or the particular website 116, for whom conversational interactions may present a more familiar and intuitive interaction modality.

As a third variation of this first aspect, the techniques presented herein may be utilized in a variety of contexts in the interaction between the user 102 and the website 116.

As a first such example, all or part of the techniques may be performed by the webserver 106 that presents the website 116, either in advance of a request by a user 102 (such that the conversational representation 204 is readily available when such a request arrives), on a just-in-time basis in response to a request of a user 102, and/or in response to a request from a developer of the website 116 or administrator of the webserver 106.

As a second such example, all or part of the techniques may be performed on the device 104 of the user 102, either in advance of requests by the user 102 (e.g., a background processing application that examines a collection of websites 116 that the user 102 is likely to visit in the future, and that assembles and stores conversational representations 204 thereof), on a just-in-time basis (e.g., a browser plug-in that assembles the conversational representation 204 while the user 102 is visiting the website 106), and/or in response to a request of the user 102. Additionally, the website 116 for which the conversational representation 204 is assembled may be local to the device 104 of the user 102 and/or provided to the device 104 by a remote webserver 106.

As a third such example, all or part of the techniques may be performed by a third-party service, such as a developer of accessibility software such as a screen reader 120 or a digital assistance, a navigation assistance device, or a wearable device such as an earpiece, or a manufacturer of a device 104, such as a digital assistance device, a navigation assistance device, or a wearable device such as an earpiece. The third-party service may assemble conversational representations 204 of websites 116 for provision to the user 102 through the software and/or device, either in whole (e.g., as a complete conversational representation 204 that the software or device may use in an offline context) or in part (e.g., as a streaming interface to the website 116). Alternatively or additionally, the third-party service may deliver all or part of the conversational representation 204 to the webserver or a content aggregating service, either for storage and later presentation to users 102 who visit the website 116 or for prompt presentation to users 102 who are visiting the website 116, such as an on-demand conversational representation service.

As a fourth such example, the techniques presented herein may be utilized across a collection of interoperating devices. For example, the conversational representation 204 of a website 116 may be assembled by one or more servers of a server farm, and the conversational representation 204 or a portion thereof may be delivered to one or more devices 104 of a user 102, which may receive and utilize the conversational representation 204 to enable a conversational interaction between the user 102 and the website 116.

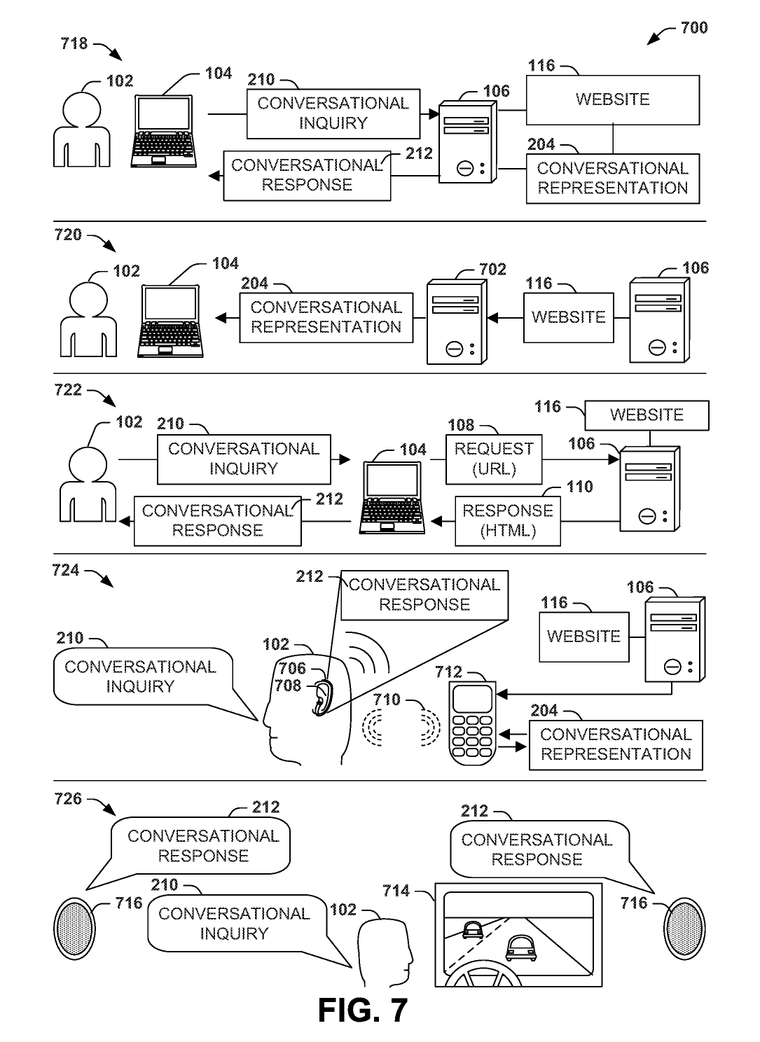

FIG. 7 is an illustration of a set 700 of example scenarios that illustrate a variety of devices and architectures in which the currently presented techniques may be utilized.

In a first example scenario 718, a webserver 106 may store a website 116 as well as a conversational representation 204 of the website 116. In some scenarios, the webserver 106 may automatically assemble the conversational representation 204 of the content elements 518 of the website 116; in other scenarios, a different device, server, or service may automatically assemble the conversational representation 204 and deliver it to the webserver 106 for storage and use to present the website 116 to various users 102. As further illustrated, a user 102 of a device 104 may submit a request to access the website 116, which the webserver 106 may fulfill by providing a conventional set of web resources, such as a set of HTML documents, images, and code such as JavaScript. Alternatively, the user 102 may submit a conversational inquiry 210 involving the website 116, which the webserver 106 may evaluate using the conversational representation 204 (e.g., identifying a conversation pair 208 that relates the conversational inquiry 210 to a selected conversational response 212), and may transmit the conversational response 212 to the device 104 for presentation to the user 102. In such manner, the webserver 106 that provides the conventional, visual layout of the website 116 may also provide a conversational interaction on a per-request basis, e.g., responsive to receiving conversational inquiries 210 from users 102.

In a second example scenario 720, a device 702 may serve as an intermediary between a webserver 106 that provides a website 116 and a device 104 of a user 102. In this second example scenario 720, a webserver 107 provides a conventional set of resources of a website 116, such as a collection of HTML documents, images, and code such as JavaScript. The device 702 may assemble a conversational representation 204 from the content elements 518 from the webserver 106 for presentation to the user 102 of the device 104. In a first such variation, the device 702 may transmit the conversational representation 204 to the device 104 for presentation to the user 102; alternatively, the device 702 may provide a conversational interaction with the website 116 on an ad hoc basis, such as by receiving conversational inquiries 210 from the user 102 and providing conversational responses 212 thereto. The device 702 may directly fulfill the conversational response 212 from a stored conversational representation 204 of the website 116, and/or may fulfill a conversational inquiry 210 by transmitting a corresponding request 108 to the webserver 106, and translating the response 110 of the webserver 106 into a conversational response 212 for presentation to the user 102. In such manner, the device 702 may provide a conversational interaction with a website 116 even if the webserver 106 provides no such support and/or cooperation in the presentation thereof.

In a third example scenario 722, a device 104 of the user 102 may assemble the conversational representation 204 of a website 116 in order to present a conversational interaction therewith. In this third example scenario 722, a webserver 106 provides a website 116 as a conventional set of resources, such as HTML documents, images, and code such as JavaScript, which the device 104 of the user 102 accesses by submitting requests 108 (e.g., URLs) and receiving responses 110 (e.g., HTML protocol replies). Alternative or additional to presenting a conventional visual layout of the website 116, the device 104 may provide a conversational interaction by assembling the response 110 and content elements 518 referenced therein into a conversational representation 204. As a first such example, the device 104 may receive an indication that the user 102 is interested in the website 116 (e.g., by identifying the website 116 among a set of bookmarks and/or recommendations of the user 102), and may preassemble a conversational representation 204 thereof (e.g., by applying a web spider to retrieve at least some of the content elements 518 comprising the website 116, and to perform an offline assembly of the conversational representation 204 to be stored and available for future on-demand use). Alternatively, the device 104 of the user 102 may perform the assembly of the conversational representation 204 upon a request of the user 102 to initiate a conversational interaction with the website 116. As yet another example, the device 104 may perform an ad-hoc assembly of requested portions of the website 116 into a conversational representation 204; e.g., as the user 102 initiates a series of conversational inquiries 210 for various web pages and resources of the website 116, the device 104 of the user 102 may translate the individual conversational inquiries 210 into requests 108, and/or may translate the responses 110 to such requests 108 into conversational responses 212 to be presented to the user 102. The device 104 of the user 102 may utilize a variety of modalities to communicate with the user 102, such as receiving the conversational inquiry 210 from the user 102 as a verbal inquiry, a typed inquiry, or a gesture, and/or may present the conversational response 212 to the user 102 as a verbal or other audible response, as a text response presented on a display or through an accessibility mechanism such as Braille, as a symbol or image such as emoji, and/or as tactile feedback. In one such example, the device 104 comprises a mobile device such as a phone that enables the user 102 to engage in a text-based conversational interaction with a website 116 that is conventionally presented as a visual layout. In such manner, the device 104 of the user 102 may provide a conversational interaction with the website 116 as an alternative to a conventional visual layout of the website 116 in accordance with the techniques presented herein.

In a fourth example scenario 724, the device 104 of the user 102 comprises a combination of devices that interoperate to provide a conversational interaction with a website 116. In this fourth example scenario 724, the combination of devices comprises an earpiece 706 that is worn on an ear 708 of the user 102 and that is in wireless communication 710 with a mobile phone 712 of the user 102. The earpiece 706 comprises a microphone that receives a conversational inquiry 210 of the user 720 involving a selected website 116, such as a verbal inquiry, and transmits the conversational inquiry 210 via wireless communication 710 to the mobile phone 712. The mobile phone 712 utilizes a conversational representation 204 (e.g., locally stored by the mobile phone 712 and/or received and/or utilized by the webserver 106 or an intermediate device 702) to generate a conversational response 212, which the mobile phone 712 transmits via wireless communication 710 to the earpiece 706. The earpiece 706 further comprises a speaker positioned near the ear 708 of the user 102, where the speaker generates an audible conversational response 212 and presents the conversational response 212 to the user 102. Either or both of these devices may utilize voice translation to interpret the verbal inquiry of the user 102 and/or speech generation to generate an audible conversational response 212 for the user 102. Either or both devices may implement various portions of the presented techniques; e.g., the earpiece 706 may cache some conversation pairs 208 that are likely to be invoked by the user 102, and the mobile phone 712 may store a complete or at least more extensive set of conversation pairs 208 that may be provided if the earpiece 706 does not store the conversation pair 208 for a particular conversational inquiry 210 received from the user 102. In such manner, a collection of devices of the user 102 may interoperate to distribute the functionality and/or processing involved in the techniques presented herein.

In a fifth example scenario 726, a user 102 operates a vehicle 714 while interacting with a device that presents a conversational interaction to a website 116. For example, a microphone positioned within the vehicle 714 may receive a conversational inquiry 210 as a verbal inquiry, and may translate the verbal inquiry relay into a request 108 that is transmitted to the webserver 106 of the website 116, wherein the response 110 is translated into a corresponding conversational response 212 as per a conversational representation 204. The conversational response 212 to the conversational inquiry 210 may be presented to the user 102, e.g., as an audible response via a set of speakers 716 positioned within the vehicle 714. This variation may be advantageous, e.g., for providing an “eyes-free” interaction between a user 102 and a website 116 that may promote the user's safe interaction with the website 116 while operating the vehicle 714. Many such devices and architectures may incorporate and present variations of the techniques presented herein.

E2. Evaluating Website Content

A second aspect that may vary among embodiments of the currently presented techniques involves the retrieval and evaluation of the content elements 518 of a website 116.

As a first variation of this second aspect, an embodiment of the presented techniques may retrieve the content items 518 of the website 116 in a single unit, such as an archive that is generated and delivered by the website 116. Alternatively, an embodiment of the presented techniques may explore the website 116 to identify and retrieve the content elements 518 thereof, such as using a web spider technique that follows a set of references, such as hyperlinks, that interconnect the content elements 518 of the website 116, and by retrieving and storing the respective content elements 518 comprising the target of each such reference (while also following any further references to other targets within the website 116 that exist in the referenced target), may compile a substantially complete collection of the content elements 518 of the website 116. As another such example, an embodiment of the presented techniques may passively collect and evaluate content elements 518, such as storing content elements 518 that are delivered by the webserver 106 on request of the user 102 during a visit; by examining the contents of a web cache on a device of the user 102 to review previously retrieved content elements 518 of the website 116; and/or by receiving new content elements 518 from a web developer that are to be published on the website 116 in a conversational representation 204 as well as a visual layout. As yet another such example, some embodiments may involve a conversational representation 204 of a locally stored website 116, such that content elements 518 need not be individually collected for such task, but may be readily available to the embodiment.

As a second variation of this second aspect, an embodiment of the presented techniques may assemble a complete conversational representation 204 of the website 116 as a holistic evaluation. For example, the embodiment may retrieve substantially all of the content elements 518 of the website 116; may cluster the content elements 518 into subsets of content and/or actions; and may develop conversation sequences of conversation pairs 208 for the respective clusters, thereby producing a comprehensive conversational representation 204 of substantially the entire website 116. Alternatively, the embodiment may identify and retrieve a selected subset of the content elements 518, such as a portion of the website 116 that pertains to a selected task (e.g., a task that the user 102 indicates an intent to perform while visiting the website 116), and may assemble a conversational representation 204 of the selected subset of content elements 518. Such selective assembly may be advantageous, e.g., as a just-in-time/on-demand assembly, such as a new website that the user 102 is visiting for the first time.

As a third variation of this second aspect, the content elements 518 may be evaluated in numerous ways. As a first such example, the content elements 518 may be semantically tagged to identify the content, context, purpose, or other details, and/or relationships with other content elements 518 on the web page. For instance, if the website comprises a form that the user 102 may complete to achieve a desired result, the content elements 518 of the form may include details for completion, such as the order in which the content elements 518 are to be completed in various cases, and whether certain content elements 518 are mandatory, optional, or unavailable based on the user's interaction with other content elements 518 of the form. As a second such example, the content elements 518 may be evaluated by a process or service that has been developed and/or trained to provide a semantic interpretation of content elements that do not feature semantic tags. In particular, various forms of contextual summarization services may be invoked to evaluate the content of the website 116, and may apply inference-based heuristics to identify the content elements 518 and interrelationships thereamong. For instance, machine vision and image recognition techniques may be applied to evaluate the contents of images presented in the website 116; structural evaluation may be performed to identify the significance and/or relationships of various content elements 518 (e.g., noting a high topical significance to images that are presented in the center and/or higher portion in a web page, and a low topical significance to images that are presented in a peripheral and/or lower portion of the web page); and linguistic parsing techniques may be applied to determine the themes, topics, keywords, purpose, etc. of text expressions, writings, and documents provided by various web pages of the website. As a third such example, outside sources of data about the web page may be utilized; e.g., if the content elements 518 of a website 116 is difficult to determine with certainty by directly inspecting the content elements 518, a search engine may be consulted to determine the semantic interpretation of the website 116, such as the categories, content types, keywords, search terms, and/or related websites 116 and web pages that the search engine attributes to the website 116. As a fourth such example, user actions may be utilized to evaluate the content elements 518 of the website 116; e.g., a first user 102 may choose to share a content item 518 with a second user 102, and in the context of the sharing the first user 102 may describe the content item 518, where the description may inform the evaluation of the content, context, topical relevance, significance, etc. of the content item 518. Other actions of various users 102 with the website 116 may provide useful information for evaluation, such as the order and/or frequency with which users 102 request, receive, and/or interact with various content elements 518. For example, the circumstances in which users 102 choose to access and/or refrain from accessing a particular content element 518, including in relation to other content elements 518 of the same or other websites 116, may inform the semantic evaluation of the content of the website 116. Many such techniques may be utilized to evaluate the content of a website 116 in accordance with the techniques presented herein.

E3. Assembling Conversational Representation

A third aspect that may vary among embodiments of the techniques presented herein involves the assembly of the conversational representation 204 of the website 116 as an organization of content elements 518 that are presented and accessible in a conversational format.

As a first variation of this third aspect, assembling the conversational representation 204 may involve maintaining a native organizational structure of the website 116. For example, the content items 518 of the website 116 may be organized by a website administrator in a manner that is compatible with a conversational interaction. The assembly of the conversational representation 204 may therefore involve a per-content-element translation to a conversational format, such as a narrative description of the respective content elements 518, and fitting the translated content elements 518 into an organization of the conversational interaction that is consistent with the native organization of the website 116. As one example, a website 116 may provide a site index, and an evaluation of the site index may both indicate the suitability of a similarly structured conversational representation 204 and suggest the organizational structure upon which conversational representation 204 is structured.

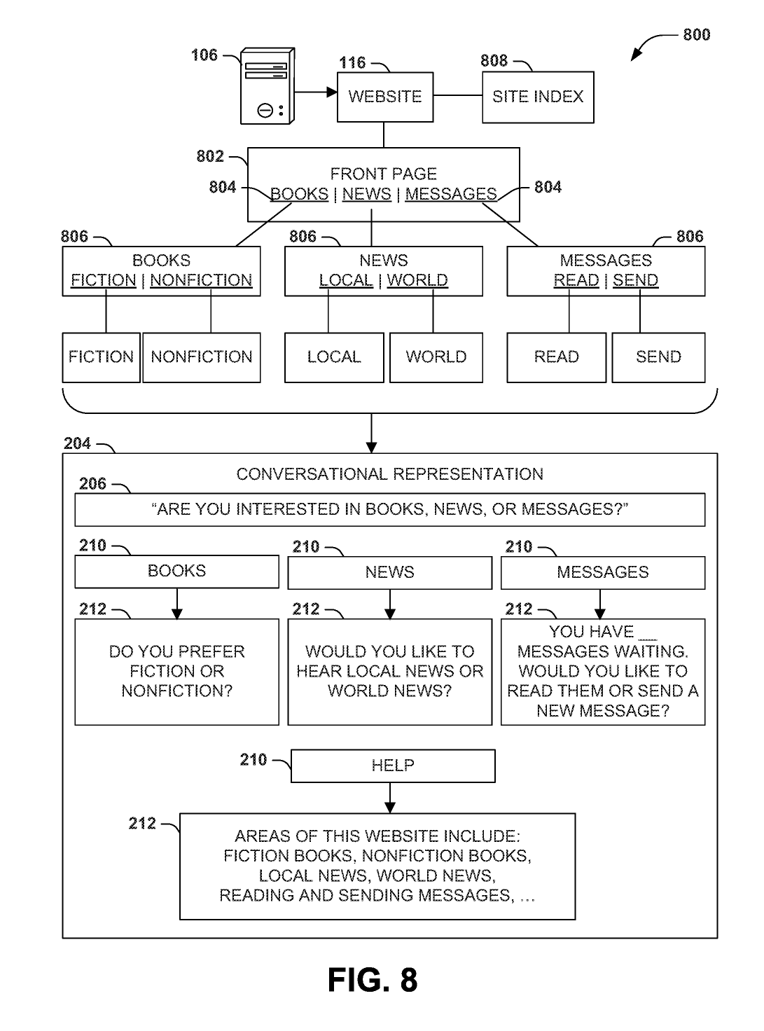

FIG. 8 is an illustration of an example scenario 800 featuring a conversational representation 204 of a website 116 with a consistent structural organization. In this example scenario 800, a device 106 provides a website 116 with a set of content items 518 arranged as a front web page 802 comprising hyperlinks 804 that respectively lead to additional web pages 806, and a site index 808 that describes the complete structure of the website 116. The conversational representation 204 may comprise an element-for-element translation of the respective web pages, beginning with a conversational prompt 206 that describes the options presented on the front web page 802 as hyperlinks, and conversation pairs 208 comprising a conversational inquiry 210 that corresponds to a selected hyperlink 804 and a conversational response 212 that corresponds to the targeted web page 806. The site index 808 may also be translated into a conversational inquiry 210 that is interpreted as a request to explore the overall structure of the website 116 and a conversational response 212 that presents, in a conversational manner, the site index 808 of the website 116. In this manner, the conversational representation 204 of the website 116 may remain consistent with the organization of the website 116 while still presenting a conversational interaction therewith.

Alternatively, the conversational representation 204 may reflect a different organization than the native organizational structure of the website 116, some of which are noted in the following variations.

As a second variation of this third aspect, assembling the conversational representation 204 may involve grouping the content elements into at least two content element groups. An embodiment of the presented techniques may assemble a conversational representation 204 of the website 116 by grouping the content elements 518 according to the respective content element groups. For instance, a website may comprise a personal blog comprising a chronologically organized series of articles about various topics, such as cooking, travel, and social events. A topical conversational structure may be more suitable for a conversational interaction than the native chronological organization of the content elements 518 (e.g., the user 102 may be less interested in choosing among content items 518 based on a chronological grouping), and may also be more suitable for a conversational interaction as compared with presenting the user with a multitude of options (“would you like to receive articles from December, or November, or October, or September, or . . . ”) Accordingly, the conversational representation 204 of the website 116 may be organized by first offering the user 102 options for receiving content elements 518 about cooking, travel, and social events.

As a third variation of this third aspect, the conversational representation 204 may be assembled by identifying a set of actions that users 102 may perform over the website 116. For the respective actions, a subset of the content elements 518 that are involved in the action may be identified, the conversational representation 204 may include a portion that presents the action to the user 102 based on the subset of the content elements 518 involved in the action. As a further example of this third variation, the assembly of the conversational representation 204 may involve estimating the frequencies with which users 102 of the website 116 perform the respective actions, and arranging the conversational representation 204 according to the frequencies of the respective actions (e.g., initially presenting conversational prompts 206 or conversational options that correspond to the highest-frequency actions that users 102 of the website 116 perform, and reducing conversational prompts 206 or conversational options for lower-frequency actions to deeper locations in the organization of the conversational representation 204).

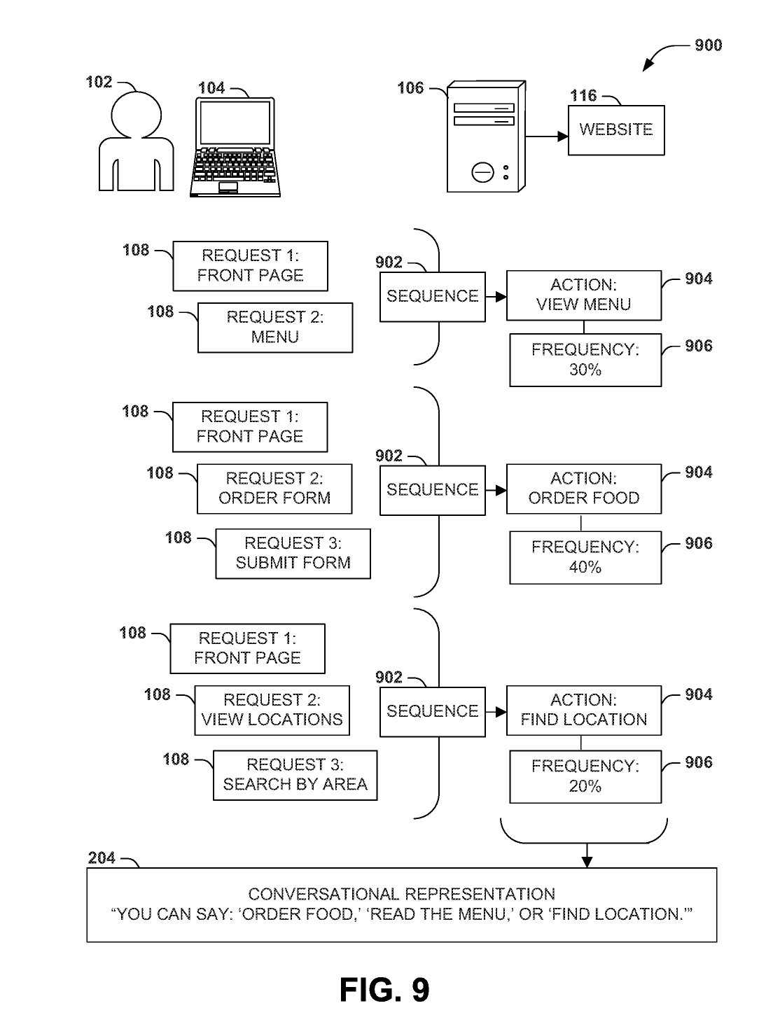

FIG. 9 is an illustration of an example scenario 900 featuring a determination of actions 904 performed by various users 102 and a corresponding organization of the conversational representation 204. In this example scenario 900, a webserver 106 of the website 116 may determine that users 102 of the website 116 often perform sequences of actions that achieve some result. For instance, users 102 of a restaurant website who wish to view a menu may typically submit a particular sequence 902 of requests 108, such as a first request 108 for the front page followed by a hyperlink selection of the “menu” action that causes the webserver 106 to present a menu. The sequence 902 may be identified as unusually frequent, indicating that users 102 often perform this particular sequence of steps. Moreover, the nature of the content elements 518 involved in this sequence 902 may suggest the nature of the action 904 (e.g., the particular information that users 102 seek while performing such actions may be presented by the last web page in the sequence 902). Moreover, among all visitors of the website 116, it may be determined that 30% of users 102 initiate this particular sequence 902 of requests 108. These findings may enable an embodiment of the presented techniques to assemble a conversational representation 204 of the website 116 that includes an option for the action 904 of viewing the menu. Similar analyses may reveal other sequences 902 of requests 108, such as a second sequence of requests 108 that users 102 initiate to perform the action 904 of ordering food (which may present an even higher frequency 906) and a third sequence of requests 108 that users 102 initiate to perform the action of finding and visiting a location (which may be performed by users 102 with a lower but still significant frequency 906). As a result, the conversational representation 204 may be organized as a collection of three actions 904 that are offered to the user 102 as a prompt at the beginning of the conversational interaction, including the ordering of the actions 904 consistent with their frequency 906 (presuming that users 102 may prefer to receive options for highest-frequency actions 906 before lower-frequency options 906).

As a fourth variation of this third aspect, assembling the conversational representation 204 may involve including, in the conversational representation 204, an index of conversational interactions for the website. For example, websites 116 with numerous options may be difficult to navigate even in a visual layout that appears very “busy,” and may be even more cumbersome to traverse through a conversational interaction. For such websites 116, it may be helpful to include, in the conversational representation 204, a conversational inquiry 210 that enables the user 102 to request help, which may provide an overview of the structure of the conversational representation 204, the current location and/or navigation history of the conversation within the conversational representation 204, and/or the conversational inquiries 210 that the user 102 may invoke at various locations. One such example is the “help” conversational inquiry 210 presented in the example scenario 800 of FIG. 8, including the conversational response 212 thereto that informs the user 102 of the top-level categories or options of the conversational representation 204 of the website 116.

As a fifth variation of this third aspect, assembling the conversational representation 204 may involve determining an interaction style for the website 116—e.g., that users 102 who visit a website 116 do so primarily to consume content in a comparatively passive manner. Other websites 116 promote more active browsing for content, such as viewing items from different categories. Still other websites 116 serve users 102 in an even more engaged manner, such as by allowing users 102 to submit search queries, apply filters to the content items, save particular content items as part of a collection, and/or share or send content items to other users 102. Still other websites 116 enable users 102 to contribute supplemental data for the content, such as ratings or “like” and “dislike” options; narrative descriptions or conversation; the addition of semantic tags, such as identifying individuals who are visible in an image; and the classification of content items, such as grouping into thematic sets. Still other websites 116 enable users 102 to create new content, such as document authoring and messaging services.

Based upon these distinctions, the styles of interactions that occurs between a user 102 and a particular website 116 may make particular types of conversational representations 204 for the website 116 more suitable to reflect the interaction style in a conversational format. For example, an embodiment of the presented techniques may involve assembling a conversational representation 204 of a website 116 by identifying a user interaction style for a particular conversational interaction (e.g., the style that users 102 frequently adopt while interacting with a particular portion of the website 116). As one example, the interaction style may be selected from a user interaction style set comprising: a receiving interaction in which users 102 passively receive the content elements of the website 116; a browsing interaction in which users 102 browse the content elements 518 of the website 116; and a searching interaction in which users 102 submit one or more search queries to the website 116.

The identification of an interaction style for a particular conversational interaction may promote the assembly of the conversational representation 204. In one such variation, conversation pairs 208 may be selected for the conversational interaction that reflect the interaction style corresponding to the user interaction style of the user interaction. For example, websites 116 that present content that users access typically in a passive manner may be structured as a monologue or extended narrative, where the device of the user 102 presents a series of content items with only minor interaction from the user 102. Websites 116 in which users 102 often engage in browsing may be structured as a hierarchical question-and-answer set, such as presenting categories or options at each navigation point within the website that the user may choose to perform a casual browsing of the hierarchy. While the conversational representation 204 is still predominantly led by the device 104, the conversation points may provide structure that allows the user to perform browsing-style navigation at each location. Websites 116 in which users 102 actively selects and performs actions may be organized as a command-driven conversation, where the user 102 is provided a set of conversational commands that may be invoked for various content items and/or at selected locations within the conversation. Websites 116 with which the user 102 actively creates content may be structured as a conversational service, where the device 104 is primarily listening to the user's descriptions to receive expressions and compile them into a larger body of content. Consistent with the previously presented example interaction style set, a conversational interaction for a narrative interaction style may involve a presentation of content elements 518 to the user 102 as a narrative stream, where the user 102 may remain passive and continue to receive content elements 518. A conversational interaction style may be assembled as a collection of conversation pairs 208 that comprise conversational inquiries 210 that select various options for interacting with the website 116 at a particular browsing location, and conversational responses 212 that navigate according to the option selected by the user 102, resulting in a presentation of a subset of content elements 518 that are related to the selected option. A query interaction style may be assembled as a collection of conversation pairs 208 that comprise a conversational inquiry 210 representing a query initiated by the user 102 and a conversational response 212 providing a result in a presentation of a subset of content items 518 that are responsive to the query. Many such types of conversation pairs 208 may be identified that reflect different conversational interaction styles with which the user 102 may choose to engage with a particular portion of the website 116.

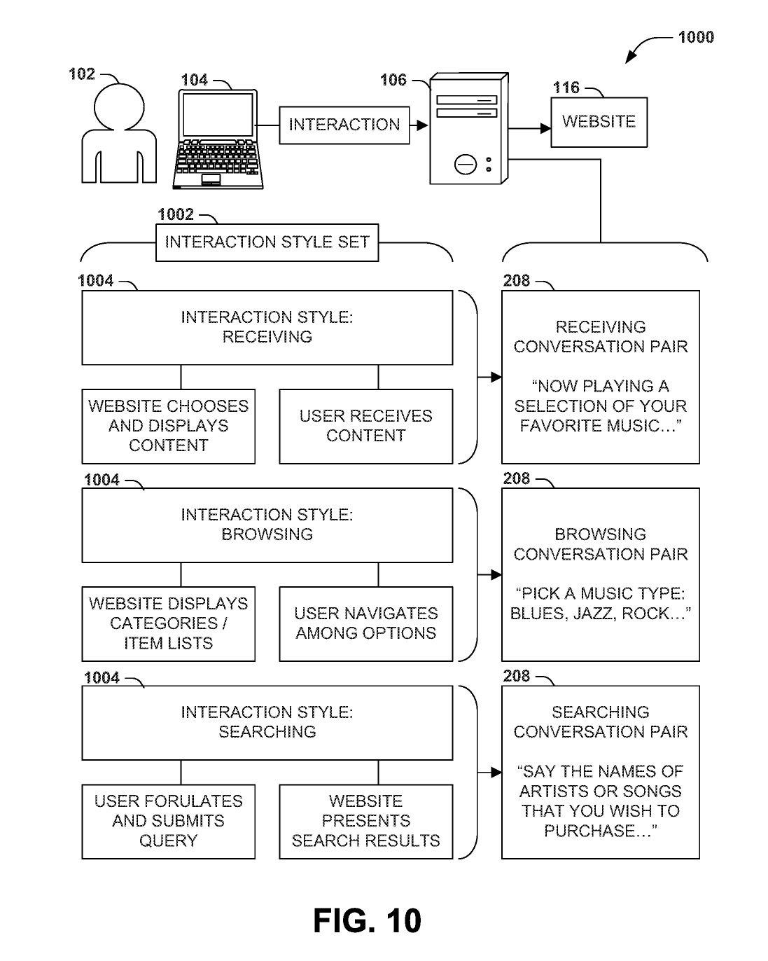

FIG. 10 is an illustration of an example scenario 1000 featuring an assembly of a website 116 as a collection of conversation pairs 208 that reflect different interaction styles 1004. In this example scenario 1000, the website 116 comprises a music library that users 102 may choose to interact with in various ways, such as receiving a stream of music; browsing among available musical collections; and searching for particular music that the user 102 wishes to hear. The assembly of the conversational representation 204 may involve a recognition of an interaction style set 1002 of interaction styles 1004 in which users 102 typically choose to interact with various portions of the website 116 (e.g., a receiving interaction style 1004 may be desirable in a “listen to music” portion of the website 116; a browsing interaction style 1004 may be desirable in an “explore” portion of the website 116; and a searching interaction style 1004 may be desirable in a “purchase” portion of the website 116). Based upon these different interaction styles 1004, different types of conversation pairs 208 may be selected for the respective portions of the website 116. For example, the browsing habits of users 102 while interacting with the website 116 may be automatically evaluated to determine the interaction style 1004 that is suitable for the various portions of the website 116 (e.g., for which portions of the website 102 are users 102 inclined to use hyperlinks, or search interfaces such as textboxes, or to remain passive and non-interactive while receiving music or other content from the website 116). A conversation pair type set may comprise different types of conversation pairs 208 that are suitable for particular interaction styles 1004, and may be correspondingly selected to model the conversation pairs 208 of various portions of the website 116. In this manner, the automatically assembled conversational representation 204 may adapt to the interaction styles that users 102 exhibit while interacting with various portions of the website 116.

As a sixth variation of this third aspect, assembling the conversational representation 204 may be based upon various interaction contexts in which a user 102 interacts with the website 116. In some such scenarios, the user 102 may interact with the website 116 in at least two interaction contexts, such as various times of day or physical locations; personal activities performed by the user 102 during which the user 102 chooses to interact with the website 116; individual roles occupied by the user 102 while visiting the website 116, such as an academic role, a professional role, and a social role; and/or various tasks and/or objectives that motivate the user 102 to visit the website 116. An embodiment of the presented techniques may assemble, for the website 116, at least two conversational representations 204 that are respectively associated with an interaction context, and that are selected for presentation to the user 102 in a particular interaction context. For example, the user 102 may interact with the website 116 in at least two roles, such as engaging a social network while the user 102 is in the role of a student; while the user 102 is in the role of a professional with a company or organization; and/or while the user 102 is in a social role. An embodiment of the presented techniques may assemble, for the website 116, at least two conversational representations that are respectively selected for presentation while the user 102 is in a particular role. The particular role may be specified by the user 102 (e.g., specifically instructing the device to interact with the user 102 in the context of an explicitly selected role) and/or may be determined via heuristic inference (e.g., the user may often operate in a student role, professional role, and social role, respectively, while interacting with the device that is located on a university campus, in a business district, and in a domestic environment).

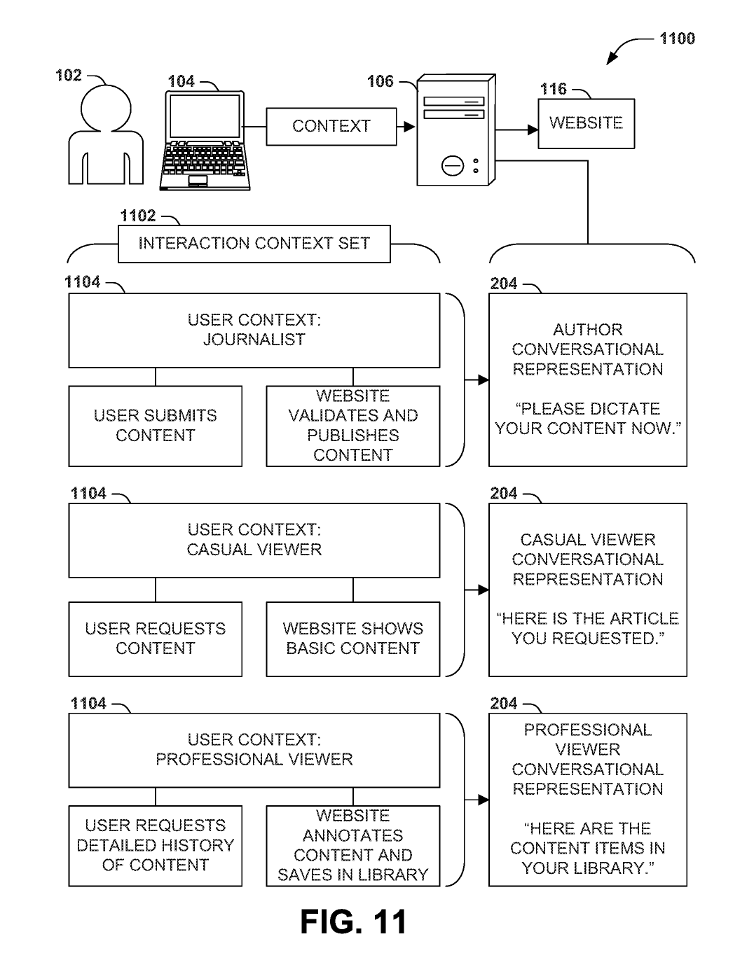

FIG. 11 is an illustration of an example scenario 1100 featuring an assembly of a website 116 as a collection of conversational representations 204 that reflect different interaction contexts 1104 in which different users 102 may interact with the website 116. In this example scenario 1100, the website 116 comprises collaborative content authoring system, in which some users 102 participate in a user context 1104 comprising the role of an author of content; other users 102 participate in a user context 1104 comprising the role of a casual viewer of the content, such as a student or hobbyist; and still other users 102 participate in a user context 1104 comprising the role of a professional viewer of the content, such as a curator of the website 116 or an academic researcher. The assembly of the conversational representation 204 may involve a recognition of the various user contexts 1104 among an interaction context set 1102 that may be adopted by various users 102. A collection of conversational representations 204 may therefore be automatically assembled for the respective user contexts 1104. A first conversational representation 204 may be assembled for users 102 in the user context 1104 of an author, which involve prompts 206, conversational inquiries 210, and conversational responses 212 that enable the user 102 to submit new content. A second conversational representation 204 may be assembled for users 102 in the user context 1104 of a casual viewer, which involve prompts 206, conversational inquiries 210, and conversational responses 212 that suggest content to the user 102 and present the user 102 with an easy-to-navigate organization of the website 116. A third conversational representation 204 may be assembled for users 102 in the user context 1104 of a professional viewer, which involve prompts 206, conversational inquiries 210, and conversational responses 212 that enable the user to query, curate, and/or organize content of the website 116. When a particular user 102 initiates a conversational interaction with the website 116, various techniques may be utilized to identify the user context 110 of the user 102 (e.g., according to an explicit request or selection of the user 102, a user profile of the user 102, and/or a set of actions that the user 102 initially performs that are emblematic of a particular user content 1104), and the corresponding conversational representation 204 may be selected and presented that matches the user context 1104 of the user 102. In this manner, the website 116 may automatically assemble and utilize conversational representations 204 that reflect a variety of user contexts 1104 in which a particular user 102 may choose to interact with the website 116.

As a seventh variation of this third aspect, assembling the conversational representation 204 may involve supplementing the conversation with a visual content element 518. For example, many conversational interactions may involve a presentation of instructions, such as vehicle navigation directions to reach a selected destination. In some circumstances, it may be easier and/or safer to present a visual map to the user 102, alternatively or additional to a verbal interaction. Accordingly, assembling the conversational representation 204 may further comprise including, in the conversational representation 204, the visual content element of the website 116 that supplements the conversational interaction. In one such example, at least one content element 518 of the website 116 may further comprise a specialized content type that involves a specialized content handler, such as an external application that generates, utilizes, consumes, and/or presents particular types of data. An embodiment of the presented techniques may include, in the conversational representation 204, a reference to the specialized content handler to be invoked to handle the specialized content type during a conversational interaction. Alternatively or additionally, in some instances, a selected content element 518 may not have any corresponding conversational presentation, such as a data set that is difficult to express in a conversational manner. An embodiment of the presented techniques may therefore exclude, from the conversational representation 204, the selected content element 518 for which a conversational presentation is unavailable.

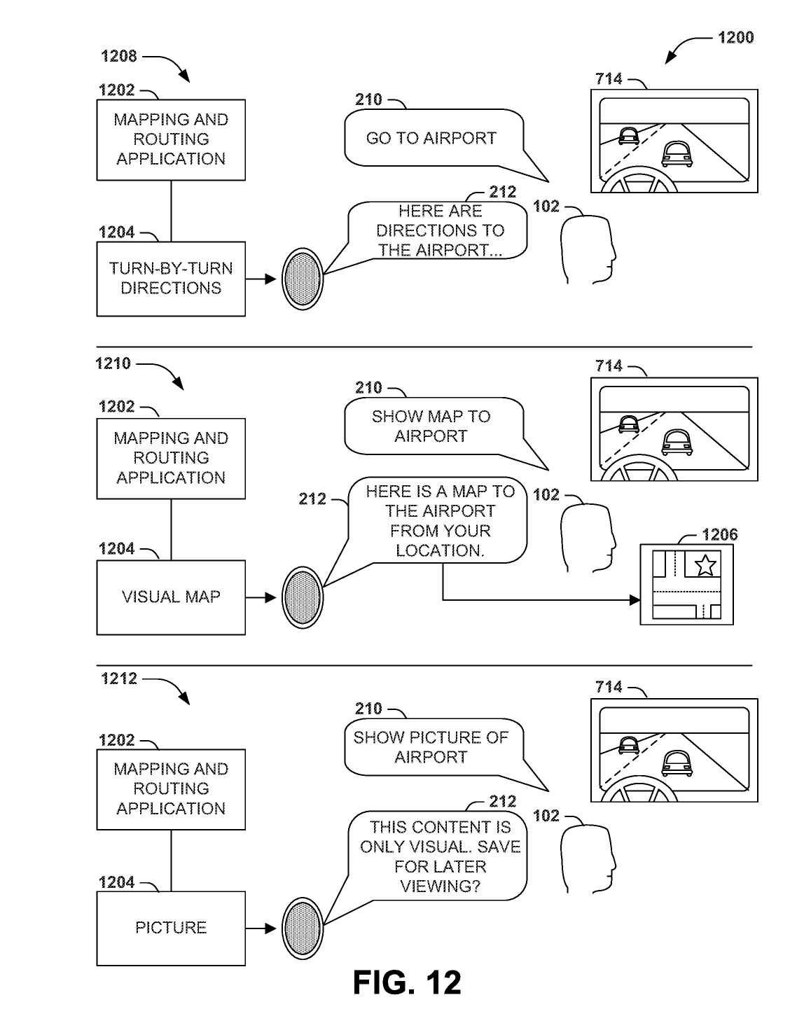

FIG. 12 is an illustration of an example scenario 1200 in which a conversational interaction between a user 102 and a device such as a vehicle 714. In this example scenario 1200, at a first time 1208, a user 102 may initiate a first conversational inquiry 210 that may be fulfilled using a conversational response 212, such as a request for driving directions to a destination. The device 714 may invoke a specialized handler 1202 to provide supplemental content 1204 that is presented to the user 102 as a conversational response 212, such as a mapping and routing application that provides a sequence of turn-by-turn directions, which the vehicle 714 may present to the user 102 using a speaker. At a second time 1210, the user 102 may initiate a second conversational inquiry 210 that is not capable of being fulfilled only as a conversational response 212, such as a request for a visual map to the airport. In some circumstances, such as the second time 1210, the conversational inquiry 210 may be safely fulfilled by supplementing a conversational response 212 with a visual content element 1206, such invoking the mapping and routing application 1202 to generate a simplified version of a map that the user 102 may safely examine while operating the vehicle 714, and presenting the map on a display within the vehicle 714. However, at a third time 1210, the user may initiate a third conversational inquiry 210 that is also not capable of being fulfilled with a supplemental visual content element 1206, such as a request for a picture of the airport that the user 102 that may be dangerous to present to the user 102 during operation of the vehicle 714. In such circumstances, even if the specialized content handler (e.g., the mapping and routing application 1202) is capable of providing the requested supplemental content 1204, the device 104 may provide a conversational response 212 that refrains from presenting and/or declines to present a supplemental content. In some embodiments, the device 104 may present other options for viewing the supplemental content, such as saving the requested picture for viewing at a later time while the user 102 is not operating the vehicle 714. In this manner, specialized content handlers may (and, selectively, may not) be invoked to generate supplemental visual content that may (and, selectively, may not) be presented to supplement a conversational interaction in accordance with the techniques presented herein.

As an eighth variation of this third aspect, alternative or additional to a conventional visual layout, a webserver 106 may provide a programmatic interface to a website 116 that comprises a set of requests, such as a web services architecture that receives requests to invoke certain functions of the webserver 106, optionally with specified parameters, and the website 106 may respond by invoking the functionality on the device and providing a machine-readable answer. Such web services are typically limited to interaction among two or more devices (e.g., many requests and responses are specified in hexadecimal or another non-human-readable format), but the currently presented techniques may be adapted to provide a conversational interaction to the web service that may be utilized by a human user 102, e.g., by assembling the conversational representation as a set of conversational interactions 208 that cover the requests of the programmatic interface. For example, assembling the conversational representation 204 may involve, for a selected request of the programmatic interface, including in the conversational representation 204 a conversational inquiry 210 that invokes the selected request, and a conversational response 212 that presents a response of the programmatic interface to the invocation.

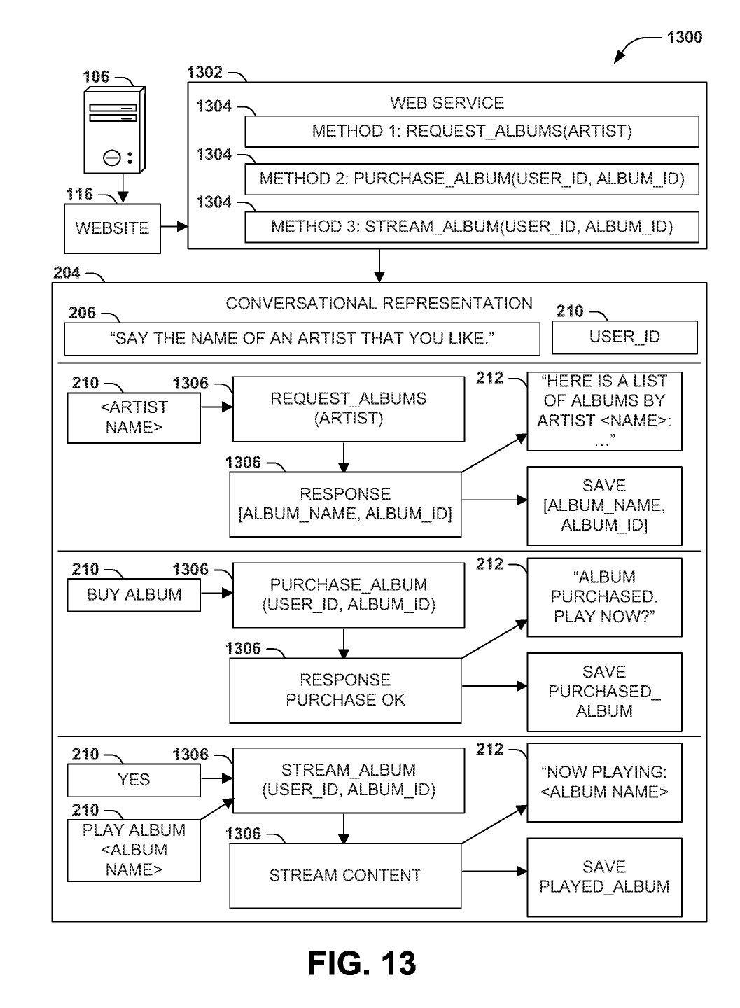

FIG. 13 is an illustration of an example scenario 1300 featuring a web services architecture 1302 that may be presented as a conversational representation 204. In this example scenario 1300, a webserver 106 may provide a website 116 that includes a collection of methods 1304 that may be programmatically invoked to initiate various functions of the website 116, such as a web services library for a music collection that includes methods 1304 such as requesting information about a music title; purchasing a music title through a particular user account; and requesting a streaming session for a purchased music title. Typically, the methods 1304 of the web services 1302 may be invoked by a device, such as a graphical user interface front-end app that invokes the functions to present the music library to the user. Alternatively or additionally to providing a conversational interaction that resembles the website 116, the webserver 106 may provide a conversational representation 204 that directly couples the user with the web services 1302. For example, the conversation pairs 208 may correspond to the methods 1304 of the web services 1302, such that a conversational inquiry 210 may be interpreted (including the extraction of a parameter, such as the name of an artist) as an invocation 1306 of a corresponding method 1304 of the web service 1302. The invocation 1306 of a method 1304 may result in a response 1306 that an embodiment may translate into a conversational response 212 for presentation to the user 102 (e.g., translating a successful result, such as a Boolean True value, into a conversational message such as “your purchase request has succeeded”). Some results may also be persisted and included as user context to supplement the interpretation of future conversational inquiries 210; e.g., a first conversational inquiry 210 may request a purchase of a particular album, and a successful purchase may result in a second conversational inquiry 210 that requests playing the album without specifically identifying the album by name. The user context of the preceding response 1306 of the web service that is stored while generating the preceding conversational response 212 may inform the interpretation of the next conversational inquiry 210 to promote the conversational interaction between the user 102 and a device 104 in accordance with the techniques presented herein.

As a ninth variation of this third aspect, the conversational representation 204 for a particular website 104 may be assembled using a collection of conversational representation templates. In this ninth variation, an embodiment may assemble a conversational representation 204 of a website from a conversational template set by selecting a conversational template for the website 116, and matching the content elements 518 of the website 116 to template slots of the conversational template. As one such example, the conversational templates of the conversational template set may be respectively associated with a website type that is selected from a website type set, and selecting the conversational template for the website 116 may further involve selecting a particular website type for the website 116 from the website type set, and selecting the conversational template of the conversational template set that is associated with the particular website type of the website 116.

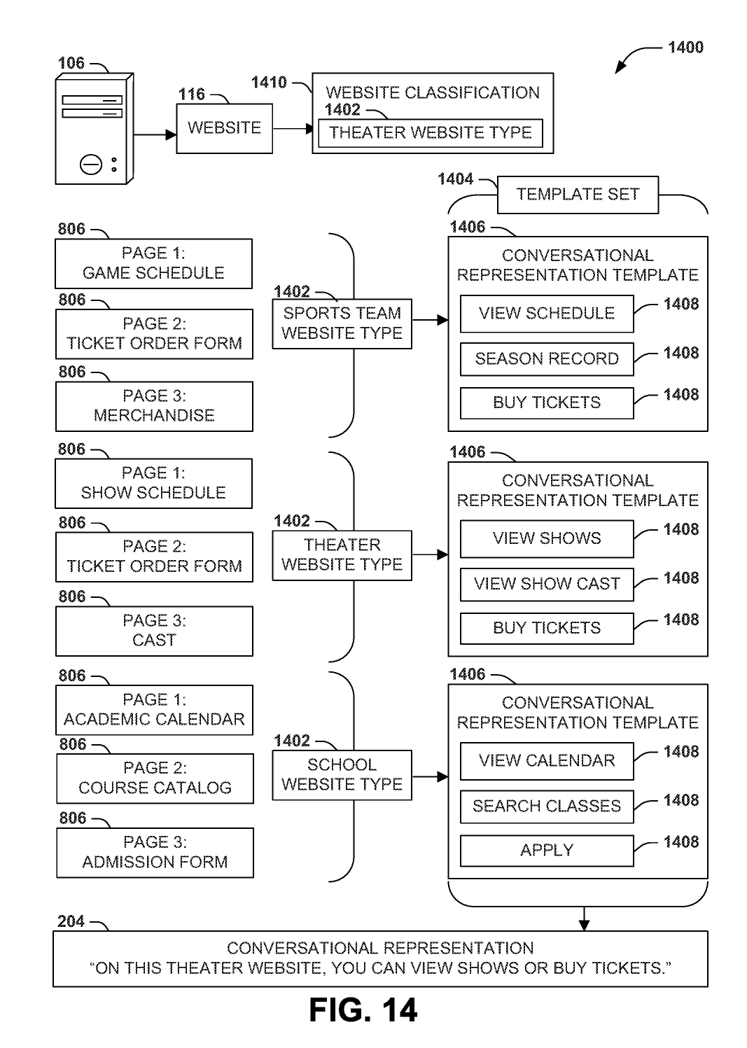

FIG. 14 is an illustration of an example scenario 1400 featuring an automated assembly of a conversational representation 204 of a website 116 using a set of conversational representation templates 1402. In this example scenario 1400, a set of website types 1402 may be identified as collections of options 1408 that are characteristically offered by such websites 116. For example, websites 116 for professional sports teams may be identified as characteristically including web pages 806 that provide a game schedule; a ticket order form; and a merchandise page. Websites 116 for theaters may be identified as characteristically including web pages 806 that provide show schedules; ticket order forms; and cast and crew descriptions. Websites 116 for schools may be identified as characteristically including web pages 806 that provide academic calendars; course catalogs; and admission forms. For each website type 1402, a template set 1404 of conversational representation templates 1406 may be provided that respectively present, in a conversational format, a collection of options 1406 that are typically exposed by websites 116 of the website type 1402. For example, the conversational representation template 1406 for a theatre website type 1402 may include conversational language that describes showtimes for a theater as “premier,” “matinee,” and “late showing” may be utilized to present a show schedule to a user 102 visiting a website 116 of a theater website type 1402. For a particular website 116, a classification 1410 may be performed to determine the website type 1402 of the website 116 (e.g., by determining the content presented by various web pages 806 of the website 116, and then determining the website type 1402 that typically presents such a collection of web pages 806), and the corresponding conversational representation template 1406 may be selected as the basis for the conversational representation 204 of the website 116, e.g., by correlating the respective web pages 806 of the website 116 into one or more of the options 1408 that are typically provided by websites 116 of the website type 1402. Some embodiments may verify that the respective options 1408 of the selected conversational representational template 1406 are provided by the website 116, and may omit, from the conversational prompt 206 and/or conversation pairs 208, entries for options 1408 that are not included by the website 116 (e.g., refraining from offering to describe the cast of a theater if the website 116 does not include a cast and crew web page 806). In this manner, an embodiment of the presented techniques may utilize conversational representation templates 1406 to promote the automated assembly of conversational representations 204 in accordance with the techniques presented herein.

As a tenth variation of this third aspect, the variety of techniques noted herein, and particularly in this section, for assembling the conversational representation 204 of the website 116 may present a variety of options, of which some options may be more suitable for a particular website 116 than other options. A variety of additional techniques may be utilized to choose among the options for assembling the conversational representation 204. As a first such example, the organization may be selected based on heuristics; e.g., a best-fit technique may be used to arrange the conversational options such that each position in the conversational hierarchy involves between three and six options. As a second such example, clustering techniques may be utilized; e.g., the conversational representation 204 of a particular website 116 may be selected to resemble previously prepared conversational representations 204 of other websites 116 with similar topical content, media, layout, or sources. As a third such example, the conversational representation 204 for a particular website 116 may be developed using a variety of processing techniques, such as lexical evaluation; natural-language parsing; machine vision, including object and face recognition; knowledge systems; Bayesian classifiers; linear regression; artificial neural networks; and genetically adapted models. As one such example, an embodiment may generate a conversational representation model that is trained by comparing the content elements 518 of a training website 116 with a user-generated conversational representation of the training website 116, and by applying the conversational representation model to a website 116 for which the conversational representation 204 is to be presented.

E4. Using Conversational Representation to Fulfill Conversational Inquiries

A fourth aspect that may vary among embodiments of the techniques presented herein involves the use of the conversational representation 204 of a website 116 to fulfill a conversational inquiry 212.

As a first variation of this fourth aspect, when a user 102 requests to interact with a website 116, an embodiment of the currently presented techniques may choose between a conversational interaction and a different type of interaction, such as a conventional visual layout, using a variety of criteria. As a first such example, the user 102 may express an instruction and/or preference for a conversational interaction, either spontaneously or responsive to prompting by a device 104 of the user 102. As a second such example, the selection between a conversational interaction and a different type of interaction may be based upon implicit factors, such as the user's preference for interaction style while previously visiting the same website 116 or similar websites 116, and/or preferences stated in a user profile of the user 102. As a third such example, the selection between a conversational interaction and a different type of interaction may be based upon contextual factors, such as the user's personal activity (e.g., choosing a conventional visual presentation while the user 102 is engaged in activities in which the user 102 can comfortably and/or safely view a visual presentation, such as riding on a bus, and choosing a conversational interaction while the user 102 is engaged in activities during which a visual layout interaction may be uncomfortable and/or unsafe, such as while driving a vehicle). As a fourth such example, the selection between a conversational interaction and a different type of interaction may be based upon the device type of the device 104 of the user 102; e.g., a first device 104 with a reasonably large display may mitigate toward a conventional visual layout, while a second device 104 with a smaller display or lacking a display may mitigate toward a conversational interaction. As a fifth such example, the selection between a conversational interaction and a different type of interaction may be based upon the content of the website 116; e.g., a first website 116 that presents numerous content elements 518 that are difficult to present in a conversational format may mitigate toward a conventional visual layout presentation, while a second website 116 that presents numerous content elements 518 that are readily presentable in a conversational format may mitigate toward a conversational interaction. As a sixth such example, the selection between a conversational interaction and a different type of interaction may be based upon the nature of the interaction between the user 102 and the website 116; e.g., if the information that the user 102 wishes to receive and/or transmit to the website 116 is suitably presented in a conversational format, the device may choose a conversational interaction, and may otherwise choose a conventional visual layout interaction.

As a second variation of this fourth aspect, the selected interaction may change during the interaction, due to changing circumstances of the interaction and/or the user 102. For example, an interaction between the user 102 and the website 116 may begin as a conventional visual layout (e.g., while the user 102 is sitting at a desk in front of a computer), but may switch to a conversational interaction as the user's circumstances change (e.g., while the user 102 is walking while listening to an earpiece device 104). Alternatively, an interaction between the user 102 and the website 116 may begin as a conversational interaction (e.g., while the user 102 is engaged in a conversational interaction to identify a content item of interest to the user 102), but may switch to a conventional visual layout interaction as the nature of the interaction changes (e.g., when the content element 518 of interest is identified, but is determined not to have a convenient conversational presentation). Many such techniques may be applied to present a conversational representation 204 of a website 116 to a user 102 in accordance with the techniques presented herein.

E5. Combining Conversational Representations

A fifth aspect that may vary among embodiments of the techniques presented herein involves the combination of conversational representations 204. As the respective conversational representations 204 are an organization of conversation pairs, the organizations of two or more conversational representations 204 may be combined in various ways to provide a conversational interaction that spans several websites 116.

As a first variation of this fifth aspect, a conversational interaction between a user 102 and a first website 116 using a first conversational representation 204 may include a transition point that transitions to a second conversational representation 204 of a second website 116. For example, a particular conversational inquiry 212 by the user 102 may cause a device to transition, within the conversational interaction, from using the conversational representation 204 of the first website 116 to a selected conversation pair 208 within the second conversational representation 204 of the second website 116.

As a first example of this first variation of this fifth aspect, the transition point may represent a hyperlink 804 within a first web page 806 of the first website 116 specifying, as a target, a second web page 806 of the second website 116. The organization conversational representations 204 for the first website 116 and the second website 116 may be substantially consistent with the hierarchical organizations of the respective websites, such that the hyperlink embedded in the first web page 806 may be assembled as part of a transitional conversation pair 208, in which the conversational inquiry 210 is within the first conversational representation 204 of the first website 116 and the conversational response 212 is within the second conversational representation 204 of the second website 116. This transitional conversation pair 208 may translate the familiar concept of web hyperlinks into conversation pairs 208 between the conversational interactions with the websites 116.

As a second example of this first variation of this fifth aspect, the transition point may represent a semantic relationship between a first content element 202 of the first website 116 and a second content element 202 of the second website 116. As a first such example, the first content element 202 may comprise a name of an entity such as an individual, place, event, etc., and the second content element 202 may be identified as a source of information about the entity, such as an encyclopedia source that describes the entity. As a second such example, the first content element 202 may topical content, such as an article or a music recording, and the second content element 202 may present further topical content that is related to the first content element 202, such as a second article on the same topic or a second music recording by the same artist. While assembling the conversational representation 204 of the first website 116 that includes a content pair 208 for the first content element 202, a device may identify the semantic relationship between the first content element 202 and the second content element 202 of the second website 116, and may insert into the conversational representation 204 of the first website 116 a transitional content pair 208 where the conversational response 212 is within the second conversational representation 204 of the second website 116.

As a third example of this first variation of this fifth aspect, the transition point may comprise an action requested by the user 102 that the content elements 202 of the second website 116 are capable of fulfilling, either as a substitute for the first website 116 (e.g., if the content elements 202 of the first website 116 are not capable of fulfilling the conversational inquiry 210) or as an alternative to the first website 116 (e.g., if the content elements 202 of the first website 116 are not capable of fulfilling the conversational inquiry 210, but if the user 102 may nevertheless appreciate at least the presentation of an alternative option for the second website 116). In such cases, a transitional conversation pair 208 may be utilized in the conversational interaction that comprises a conversational inquiry 210 and a conversational response 212 that transitions to a second content element 202 of the second website 116.

Many such scenarios may lead to the inclusion of a transitional content pair 208 of this nature. For example, the transitional conversation pair 208 may be generated on an ad hoc basis, such as where the user 102 initiates a conversational inquiry 210 that does not match any conversation pair 208 of the conversational representation 204 of the website 116. A device may also store a collection of default transition conversation pairs 208 that are related to various websites 116, which are applicable to handle any conversational inquiry 210 for which no conversation pair 208 is included in the conversational representation 204 upon which the current conversational interaction is based. Alternatively or additionally, a transitional conversation pair 208 may be generated in advance and included in the conversational representation 204 of the first website 116. One instance where such inclusion may be achieved is the application of a conversation representation template 1406 based upon the website type of the website 116, but where a particular action within the conversational representation template 1406 is missing from the website 116. As another example, an interaction history of the user 102 or other users 102 with a particular website 116 may include a particular conversational inquiry 210 that the user 102 is likely to provide for a particular website 116, but that the content elements 202 of the website 116 do not currently satisfy (e.g., because such content elements 202 are not included in the website 116, or because such content elements 202 were previously present but have been removed or disabled). In such scenarios, it may be advantageous to anticipate a user's formulation of the conversational inquiry 210, and to include in the conversational representation 204 a transitional conversation pair 208 that directs the conversational interaction to the conversational representation 204 of a different website 116 that is capable of handling the conversational inquiry 210. As still another example, a transitional conversation pair 1504 may be provided to address an error, such as a failure or unavailability of a method 1304 of a web service 1302, such that conversational representation 204 is capable of addressing an invocation of the method 1304 that results in an error (e.g., by transitioning the conversational interaction from a first website 116 that is incapable of handling the request to a second website 116 that may provide such capability).

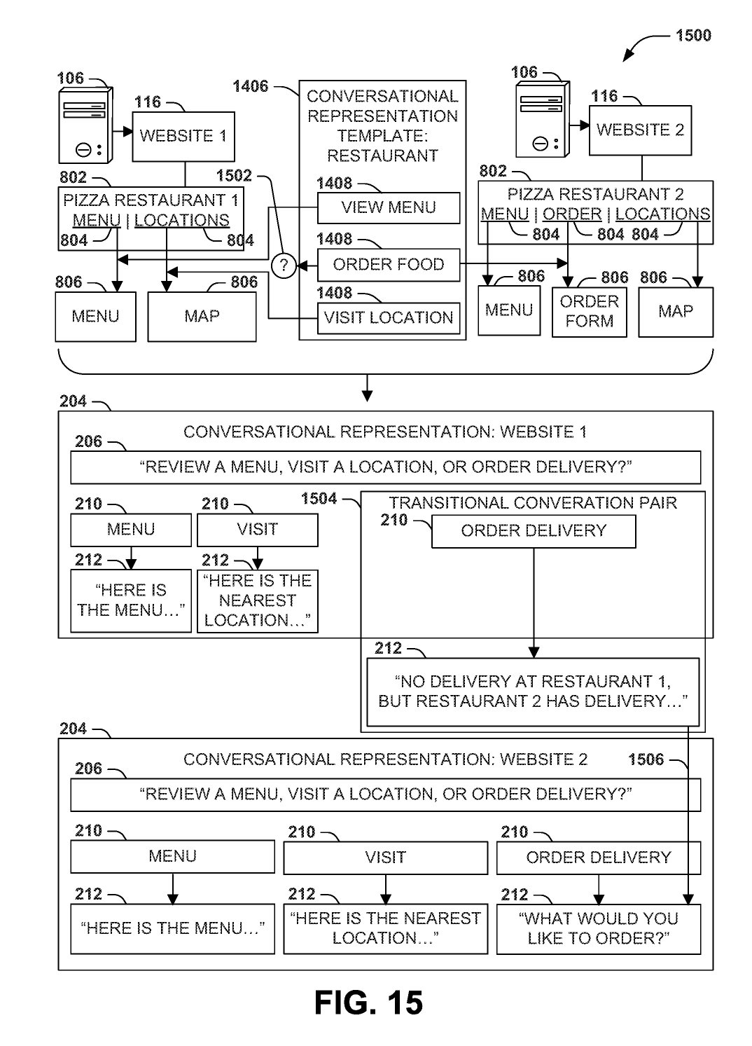

FIG. 15 is an illustration of an example scenario 1500 featuring a transitional conversation pair 1504 that transitions a conversational interaction from a first website 116 to a second website 116. In this example scenario 1500, a conversational representation 204 for a first website 116 and a second website 116 has been assembled using a conversational representation template 1406 that matches a website type of the websites 116. The respective options 1408 that are typically included in websites 116 of the website type are compared with the content elements 202 of each website 116, and conversation pairs 210 are generated therefor. However, in the process, a device assembling the conversational representation 204 for the first website 116 may discover that a particular option 1408 is missing 1502 from the content elements 202 of the first website 116—e.g., that an option to order delivery online, which is typical of such websites 116, is not provided by the first website 116. In anticipation of a user's request for such an option 1408, the device that is assembling the conversational representation 204 may instead determine that the option 1408 is provided by the second website 116, and may therefore include in the conversational representation 204 a transitional conversation pair 1504 where the conversational inquiry 210 is included in the first conversational representation 204, and the conversational response 212 provides a transition to a second conversational response 212 in the conversational representation 204 of the second website 116. In this manner, the inclusion of the transitional conversation pair 1504 in the conversational representation 204 of the first website 116 may proactively address the absence of the option 1408 among the content elements 202 of the first website 116.

As a second variation of this fifth aspect, when a conversational interaction between a user 102 and a first website 116 includes a transition to a second website 116, a variety of techniques may be included to inform the user 102 of the transition and to enable the user 102 to control the conversational interaction. It may be advantageous to do so, e.g., to avoid a transition of the conversational interaction of which the user 102 or does not wish to perform. In the example scenario 1500 of FIG. 15, the conversational representation 204 includes a transitional conversation pair 1504 that fulfills a conversational inquiry 210 by a user 102 to place a delivery order from a first pizza restaurant (where the first website 116 does not provide an online delivery option 1408) by instead placing an order through a second pizza restaurant, and the user 102 may be surprised and/or dissatisfied if this transition is not clearly conveyed to the user 102. As a first such example, during or prior to the transition point, a device may notify the user 102 of the transition to the second website 116 (such as in the example scenario 1500 of FIG. 15), and may notify the user 102 of the reason for the transition (e.g., informing the user 102 that the first website 116 does not have a delivery option 1408). The device may also may provide the user 102 an opportunity to confirm and/or stop the transition of the conversational interaction. As a second such example, when the conversational inquiry 210 that prompted the transition has been fulfilled by the conversational interaction with the second website 116, the device may return to the conversational representation 204 of the first website 116 (optionally notifying the user 102 of the return transition, and/or providing an opportunity to confirm and/or stop the return transition). Alternatively, the conversational interaction may remain within the conversational representation 204 of the second website 116. A device may also allow the user 102 to choose between the first website 116 and the second website 116 for the continuation of the conversational interaction.

As a third variation of this fifth aspect, during a conversational interaction with a first website 116, a device may compile a conversational context (e.g., the user's preferences and/or selections of pizza toppings, as specified by the user 102 while interacting with the first website 116). As part of transitioning to a conversational interaction with a second website 116, a device may maintain the conversational context, which may promote convenience to the user (e.g., translating the user's choices for pizza toppings when ordering from the first website 116 to an order placed through the second website 116). Alternatively, a device may restrict the conversational context between the user 102 and the first website 116 to such interactions, and may initiate a new conversational context between the user 102 and the second website 116 as part of the transition, which may promote the user's privacy in interacting with different websites 116. A device may also give the user 102 a choice between translating the context to the conversational interaction with the second website 116 or refraining from doing so.

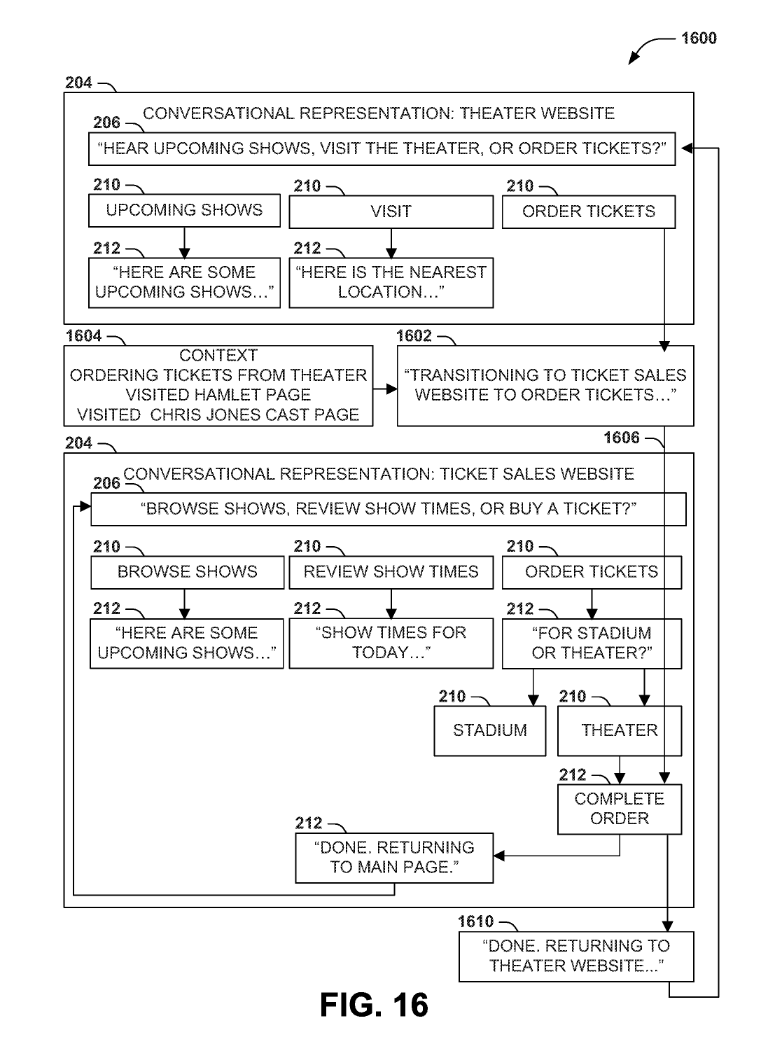

FIG. 16 is an illustration of an example scenario 1600 that involves various techniques for presenting a transition between conversational interactions with two website 116. In this example scenario 1600, a first website 116 for a theater may provide options for information about the productions of the theater, but may not provide content elements 202 for ordering tickets; rather, the first website 116 may provide a hyperlink to a second website 116 that facilitates an action 214 of ordering tickets. A device may assemble a conversational representation 204 that represents the hyperlink as a transitional conversation pair 1504 that transitions the conversational interaction to a second conversational representation 204 for the second website 116. As further shown in this example scenario 1600, the transitional conversation pair 1504 may include, in the conversational response 212 to the “order tickets” conversational inquiry 210, a notification 1602 that the conversation is transitioning to the second website 116, as well as an explanation of the reason for the transition (e.g., to enable the user 102 to perform the action 214 of purchasing tickets). As a second such example, a context 1604 of the interaction between the user 102 and the first website 116 that prompted the transition may be included in the transition (e.g., rather than initiating a ticket ordering action 214 with no information, the transition may initiate a ticket ordering action 214 for the particular show that the user 102 was exploring on the first web page 116). As a third such example, following completion of the action 214, the conversational representation 204 for the action 214 may either return to a conversational prompt 206 of the second website 116 or may provide a return transition 1610 to a conversational prompt 206 for the first website 116. In this manner, the conversational inquiry may utilize a variety of techniques to facilitate transitions among websites 116.

As a fourth variation of this fifth aspect, rather than utilizing transitions between websites 116 to supplement the interaction between the user 102 and the first website 116, an embodiment of the currently presented techniques may assemble a merged conversational representation 204 as an organization of content elements 202 of multiple websites 116. That is, the conversation pairs 208 provided in the conversational representations 204 of multiple websites 116 may be merged to provide a conversational interaction that aggregates the content of the websites 116. For example, a device that has access to a first conversational representation 204 of a first website 116 and a second conversational representation 204 of a second website 116 may produce a merged conversational representation that includes conversation pairs 208 from both conversational representations 204, e.g., by merging at least a portion of the first conversational representation 204 and at least a portion of the second conversational representation 204 into a merged conversational representation that provides a conversational interaction spanning the first website 116 and the second website 116. As a first such example, merging may occur horizontally, e.g., by including a first conversation pair 208 from the first conversational representation 204 and a second conversation pair 208 from the second conversational representation 204 as alternative options at a particular location in the merged conversational representation. As a second such example, merging may occur vertically, e.g., by including a first conversation pair 208 from the first conversational representation 204 that leads to a second conversation pair 208 from the second conversational representation 204 as a sequential interaction with both websites 116. As an alternative to merging conversational representations 204, a device may directly produce a merged conversational representation 204 by aggregating the content elements 202 of multiple websites 116. Using such a merged conversational representation, a device may provide a conversational interaction between the user and an amalgamation of at least two websites 204.

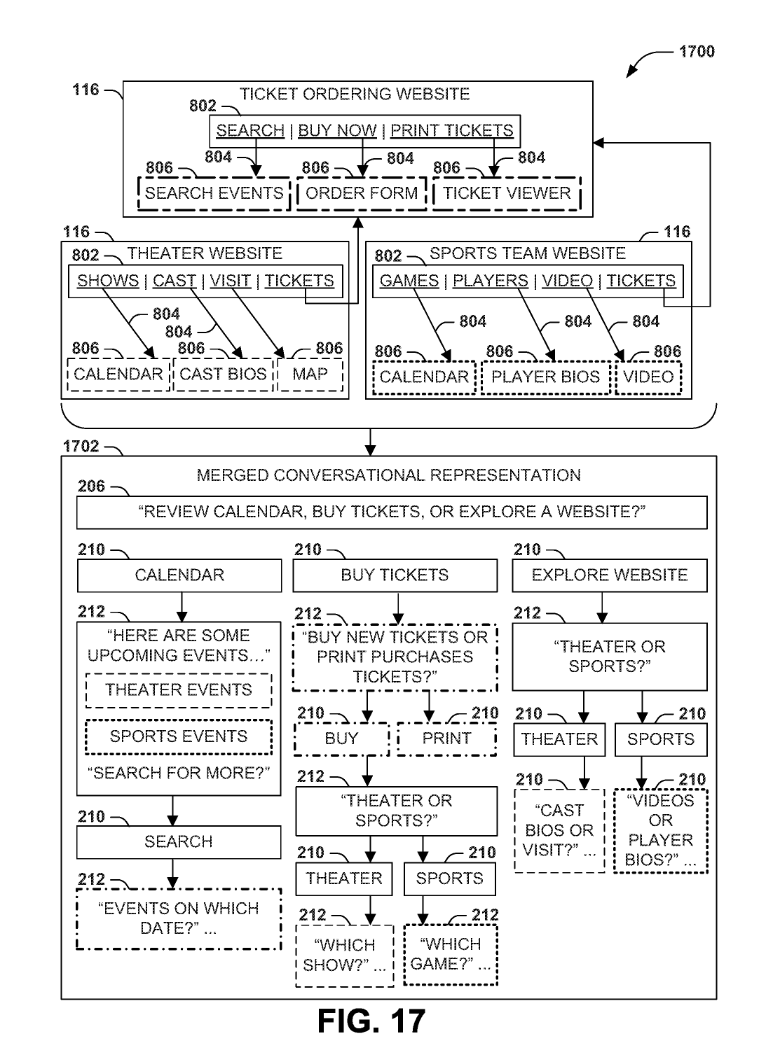

FIG. 17 is an illustration of an example scenario 1700 featuring a merged conversational representation 1702 to provide a conversational interaction that aggregates multiple websites. This example scenario 1700 involves three websites 116: a first website 116 representing a theater; a second website 116 representing a sports team; and a third website 116 representing a ticket ordering service through which tickets can be ordered for both theater shows and sports games. A device may assemble a merged conversational representation 1702 that combines the content elements 202 of these three websites 116 in various ways. As a first such example, similar content elements 202 on different websites 116 may be combined into a single conversation pair 208; e.g., the merged conversational representation 1702 may include a “calendar” action 214 that, when initiated by a conversational inquiry 210 to review a calendar of events, presents content elements 202 from the “calendar” web pages 806 of both the theater website 116 and the sports team website 116, as well as an event search action 214 that is provided by the ticket ordering website 116. This example reflects both horizontal merging (e.g., combining the events from multiple calendars) and vertical merging (e.g., providing the calendar interaction, sequentially followed by a conversational inquiry 210 that is fulfilled using content elements 202 from the ticket ordering service). As a second such example, other portions of the merged conversational representation 1702 may present alternative options for exploring individual websites 116, such as a conversational inquiry 210 to explore a website followed by a conversational response 212 that elicits a user selection among the websites 116 that may be explored. As a third such example, other portions of the merged conversational representation 1702 provide a sequence of interactions that utilizes the content elements 202 of several websites 116; e.g., the ticket ordering process allows the user 102 to select an event from among the entries of the calendar web pages 806 of the theater website 116 and the sports team website 116, and then initiates an action 214 to purchase tickets for the selected event through the ticket ordering website 116. In this manner, the merged conversational representation 1702 provides a conversational interaction spanning multiple websites 116. Moreover, the organization of the merged conversational representation 1702 is distinct from the organization of each of the individual websites 116; rather, the merged conversational representation 1702 may be automatically by clustering similar content elements 202 from multiple websites 116, irrespective of where such content elements were positioned in the hierarchical structure of the original website 116. Many such techniques may be utilized to combine conversational representations 204 of websites 116 as part of a conversational interaction in accordance with the techniques presented herein.

E6. Action Sets

A sixth aspect that may vary among embodiments of the presented techniques involves the assembly of an action set of actions that respectively correspond to conversational interactions with websites 116.

As previously discussed, a portion of a website 116 may provide an action 214, such as an order form that enables the submission of an order for food. A website 116 may provide a set of actions 214 as groups of content elements 202 that are assembled into a conversational representation 204 to allow the actions 214 to be invoked by a user 102 during a conversational interaction between the user 102 and the website 116 (e.g., by providing a series of conversation prompts 208 that elicit information from the user 102 that may be used to complete the action 214, such as the user's selection of pizza toppings). Moreover, the reverse process may be applied: when a user 102 initiates a request to perform an action 214, an embodiment of the presented techniques may initiate a conversational interaction with a website 116 that is capable of fulfilling the action 214 requested by the user 102. Such a conversational interaction may be initiated even if the user 102 did not initially specify a website 116 that the user 102 wishes to utilize to perform the action 214 (e.g., the user 102 may not know of any websites 116 or even restaurants that provide pizza delivery, but may simply initiate a request for pizza delivery).

According to these observations, in a first variation of this sixth aspect, an embodiment of the currently presented techniques may initially receive, from the user 102, an initial conversational inquiry that does not reference a website 116. The device may determine that the initial conversational inquiry is topically related to a particular website 116, and may fulfill the initial conversational inquiry by initiating the conversational interaction between the user 102 and the website 116 using the conversational representation 204 of the website 116. That is, a device may store, in a memory, an action set of actions 214 that are respectively invokable over a selected website 214, wherein respective actions 214 are associated with at least one associated conversation pair 208 of an associated conversational representation 204 of the selected website 116. While evaluating a particular website 204, the device may associate at least one conversation pair 206 of the conversational representation 204 of the website 116 with an action 214 in the action set. The device may then provide a conversational interaction by receiving, from the user 102, an initial conversational inquiry to perform the action 214; identifying, in the action set, a selected conversation pair 208 of the conversational representation 204 of the website 116 that is associated with the action 214; and initiating the conversational interaction between the user 102 and the website 116 using the conversational representation 204.

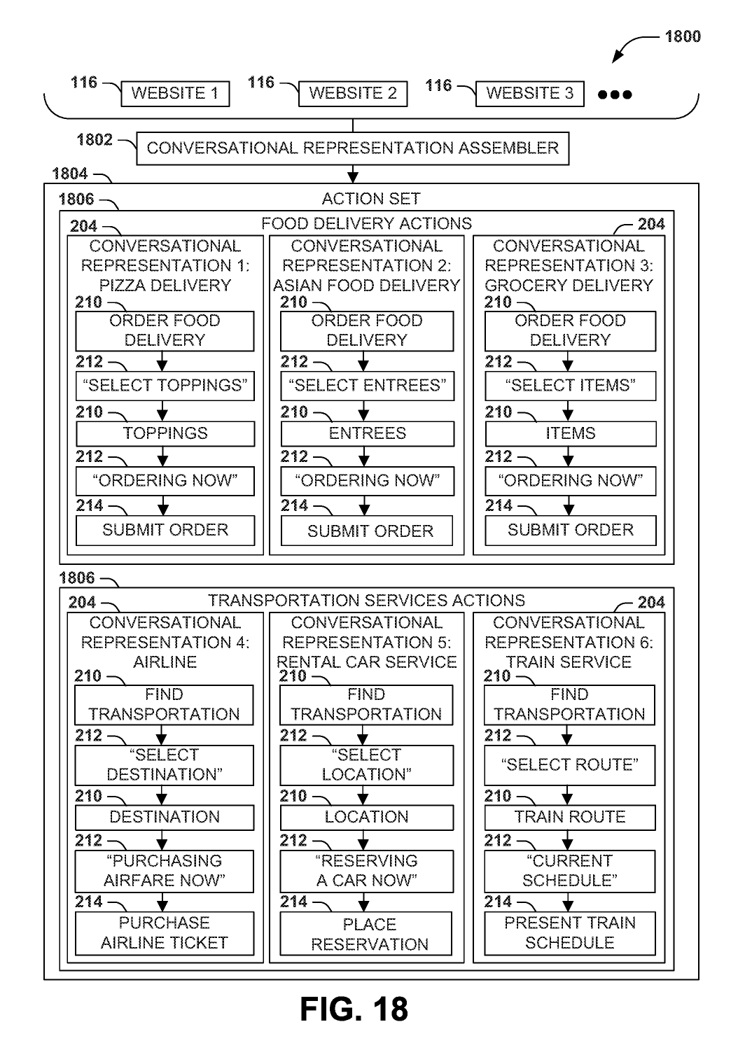

FIG. 18 is an illustration of an example scenario 1800 in which a conversational representation assembler 1802 is utilized to synthesize a set of websites 116 into an action set 1804 of actions 214. In this example scenario 1800, a device may evaluate the content elements 202 of a number of websites 116, and for each such website 116, may identify one or more actions 214 that the website 116 enables and assemble a conversational representation 204 that performs the action 214 through a conversational interaction with the user 102. Additionally, the actions 214 may be grouped into an action set 1804 comprising conversational representation sets 1806 corresponding to various actions 214 that the user 102 may perform (e.g., ordering food and arranging transportation to a destination). A particular action 214 that is requested by a user 102 by choosing a conversational representation 204 from the conversational representation group 1806 for the action 214, even if the user 102 did not request a particular website 116 to perform the action 214.

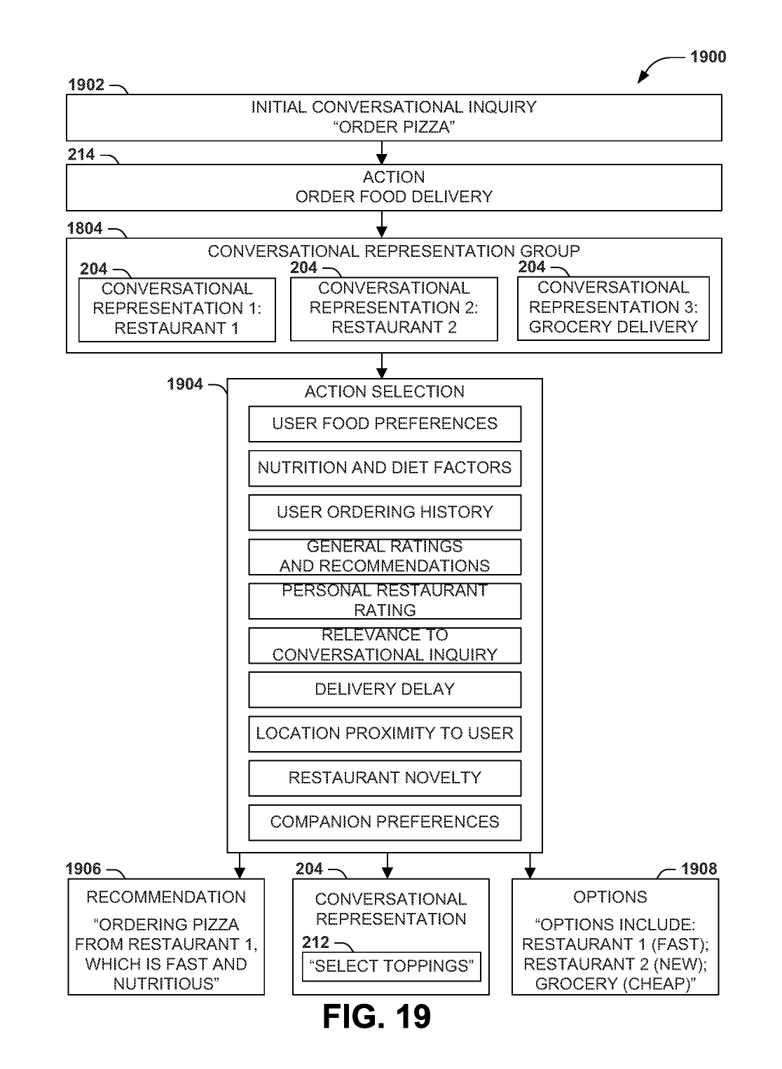

FIG. 19 is an illustration of an example scenario 1900 featuring a selection of a website 116 from a website set to perform an action 214 requested by a user 102. In this example scenario 1900, an initial conversational inquiry 1902 is received from a user 102. The initial conversational inquiry 1902 is evaluated to identify an action 214 that the user 102 is requesting, but not necessarily a particular website 116 to be utilized to perform the action 214. Instead, an embodiment of the presented techniques may identify a conversational representation group 1804 that is associated with the action 214, and that comprises a set of conversational representations 204 of respective websites 116 that are capable of performing the action 214. Moreover, the conversational representations 204 may each perform the action 214 but in different ways, such as ordering from different restaurants and ordering the ingredients for pizza from a grocery delivery service. An embodiment of the currently presented techniques may therefore endeavor to fulfill the action 214 for the user 102 by first performing an action selection 1904 that determines the manner in which the action 214 may be performed by selecting from the available conversational representations 204. For example, the action selection 1904 may involve a consideration of the food preferences of the user 102, and/or nutrition and diet factors of the options, such as whether the options are consistent with the user's dietary needs. The action selection 1904 may also involve a review of the user's ordering history, such as whether the user 102 has previously selected any of the websites 116 in similar circumstances. The action selection 1904 may also involve a review of general ratings and recommendations among the respective options, as well as the user's personal restaurant ratings if the user 102 has previously visited either of the restaurants. The action selection 1904 may also involve a review of the relevance of the respective options to the initial conversational inquiry 1902 (e.g., the first restaurant may specialize in pizza, while the second restaurant may specialize in pasta or another type of food and may only offer pizza as a secondary selection). The action selection 1904 may also involve a review of the delivery delay of the providers in fulfilling the action 214 and/or the proximity of the location of the respective options to the user 102. The action selection 1904 may also involve the novelty of the options (e.g., some users 102 may occasionally prefer to try new options, while other users 102 may prefer a consistent choice of familiar options) and/or the preferences of any companions to the user 102.

Based on the action selection 1904, the device may choose a website 116 and may initiate a conversational interaction between the user 102 and the selected website 116 through the use of a previously assembled conversational representation 204. Additionally, an embodiment may present a recommendation 1906 (e.g., describing the website 116 selected by the action selection 1904, and optionally indicating the factors that motivated the selection), and/or may present a set of a few options 1908 with a comparative description of the factors that mitigate toward the selection thereof, and may respond to a selection of an option 1908 received from the user 102 by initiating a conversational representation 204 with the website 116 of the selected option. In this manner, an embodiment of the presented techniques may fulfill the initial conversational inquiry 1902 of the user 102 despite the absence in the initial conversational inquiry 1902 of any indication of which website 116 and conversational representation 204 to utilize to fulfill the action 214.

As a second variation of this sixth aspect, a user 102 may submit an initial conversational inquiry 1902 that does not only provide an action 214, but that specifies a request at an even higher level of generality that may involve a combination of actions 214 over a variety of websites 116. In order to fulfill the initial conversational inquiry 1902, an embodiment may first have to determine a set of actions 214 that are requested by the initial conversational inquiry 1902. The set of actions 214 may include a combination of concurrent and independent actions 214 (e.g., ordering food delivery of two different types of cuisine from two different websites 116); a sequence of actions 214 through one or more websites 116 (e.g., ordering food delivery from a restaurant that does not deliver by placing a carry-out order through the website 116 of the restaurant, and then placing a courier delivery service request from a courier website 116); and/or conditional actions 214 (e.g., purchasing tickets to an outdoor event only after checking that the weather during the event will be satisfactory). In some circumstances, the output of one action 214 may be utilized as input for another action 214; e.g., a first action 214 comprising a query of a weather service may produce a weather prediction at the time of a requested restaurant reservation, and the weather may affect a second action 214 comprising a completion of the restaurant reservation with a request for indoor or outdoor seating, based on the weather prediction. In such circumstances, a device may evaluate the initial conversational inquiry 1902 in a variety of ways, such as linguistic parsing to evaluate the intent of the initial conversational inquiry 1902 and the use of action templates that provide combinations of actions 214 that collectively fulfill the initial conversational inquiry 1902.

As one example, a workflow may be devised that indicates the sequence of actions 214 to be performed to fulfill the initial conversational inquiry 1902. In order to perform portions of the workflow that involve user interaction with the user 102 (e.g., clarifying the initial conversational inquiry 1902; soliciting additional information, such as the user's preferences for restaurants; and verifying and/or committing to various portions of the workflow), an embodiment of the presented techniques may utilize portions of the conversational representations 204 of various website 116. An embodiment of the currently presented techniques may assemble a workflow of actions 214 that together satisfy the initial conversational inquiry 1902, and may initiate conversational interactions between the user 102 and various websites 116 through the conversational representation 204 thereof to fulfill the respective actions 214 of the workflow.

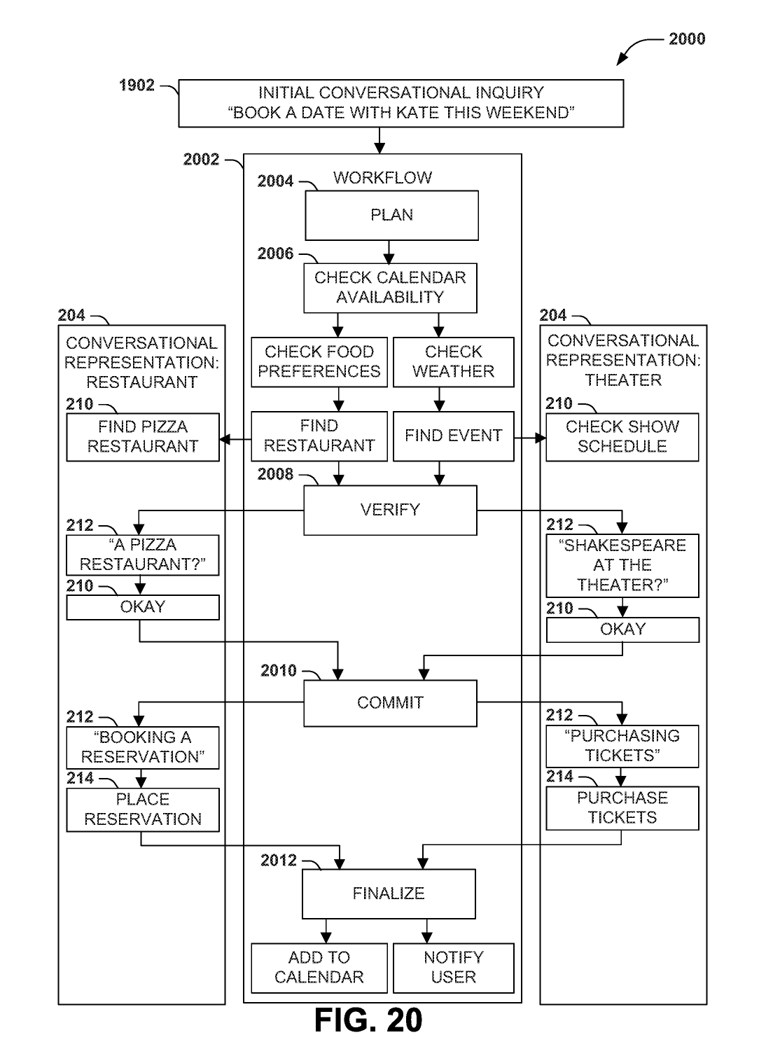

FIG. 20 is an illustration of an example scenario 2000 featuring the use of a workflow to fulfill an initial conversational inquiry 1902. In this example scenario 2000, a user initiates the conversational interaction with various websites by specifying the initial conversational inquiry 1902, which neither specifies a particular website 116 to use nor even clearly indicates the actions to be performed. Instead, an embodiment of the currently presented techniques may first identify a workflow 2002 as a combination of actions 214 that are to be completed to fulfill the initial conversational inquiry 1902. In this example scenario 2000, the workflow 2002 comprises a series of stages, such as a planning stage 2004 (e.g., soliciting information from various websites 204 that may satisfy various portions of the workflow, such as checking 2006 a calendar for availability and searching for actions 214 that involve finding a restaurant and finding an event); a verifying stage 2008 that presents the plan to the user 102 for confirmation; a committing phase 2010 that commits reservations; and a finalizing phase 2012 that adds the events to the user's calendar and notifies the user 102 of the committed reservations.

In particular, the actions 214 that involve user input with the user 102 may be achieved by invoking portions of the conversational representations 204 thereof. As a first example, the tasks of finding a restaurant and finding an event may be satisfied, e.g., by invoking actions within the respective conversational representation groups 1806 of an action set 1804. As a second example, the verifying step 2008 may involve invoking the portions of the respective conversational representations 204 that describe the restaurant and the event to the user 102 as a recommendation, contingent upon the user's assent. As a third example, the committing step 2010 may be performed by invoking the actions 214 over the websites 116 in accordance with the conversational representations 204, using the same portions of the conversational representations 204 that are utilized when a user 102 requests a reservation at the restaurant and a purchase of tickets for the theater. Because the conversational representations 204 are available to fulfill such conversational inquiries of the user 102, the conversational representations 204 may also be suitable to fulfill specific actions 214 of the workflow 2002, including user interaction to describe, perform, and report such actions 214. In this manner, the example scenario 2000 utilizes the conversational representations 204 to fulfill the workflow 2002 with the assistance of the user 102. Many such solutions may be utilized to fulfill the initial conversational inquiries 1902 of users 102 in accordance with the techniques presented herein.

### F. Computing Environment

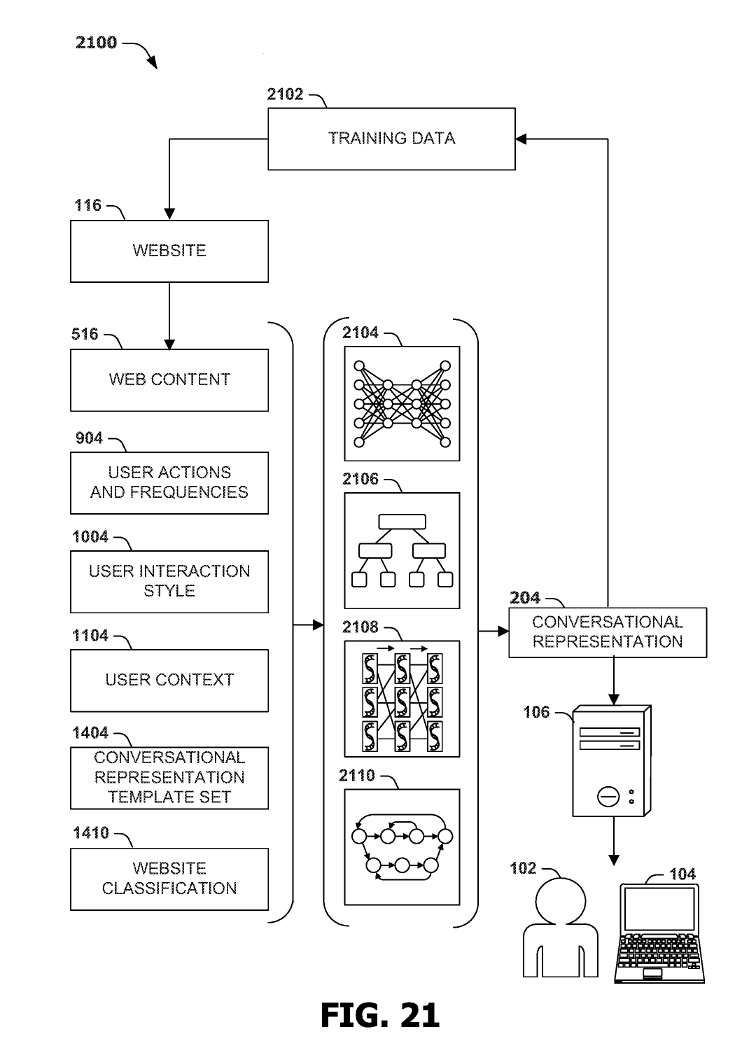

FIG. 21 is an illustration of an example scenario 2100 featuring a variety of adaptive algorithms that may be utilized to generate a conversational representation 204 of a website 116. In this example scenario 2100, a website 116 is provided that presents a collection of web content 516, as well as other information about the website 116, such as user actions and frequencies 904; user interaction styles 1004; and user contexts 1104, such as the roles of various users 102 who may interact with the website 116. Additionally, a conversational representation template set 1404 may be provided, along with a website classification 1410 of the website 116 based (e.g.) upon its web content 516. This information may provided to one or more adaptive algorithms, such as an artificial neural network 2104, a Bayesian classifier 2106, a genetically evolving algorithm 2108, and/or a finite state machine 2110, where the output of the selected adaptive algorithm(s) applied to the input data is the assembly of a conversational representation 204 of the website 116. In addition to enabling a conversational interaction between a user 102 of a device 104 and the website 116, the conversational representation 204 may be added to a set of training data 2102 that is utilized to train the adaptive algorithm(s) for the automatic assembly of further conversational representations 204 of other websites 116. In this manner, the use of adaptive algorithms may promote the automatic generation of conversational representations 204 of websites 116 in accordance with the techniques presented herein.

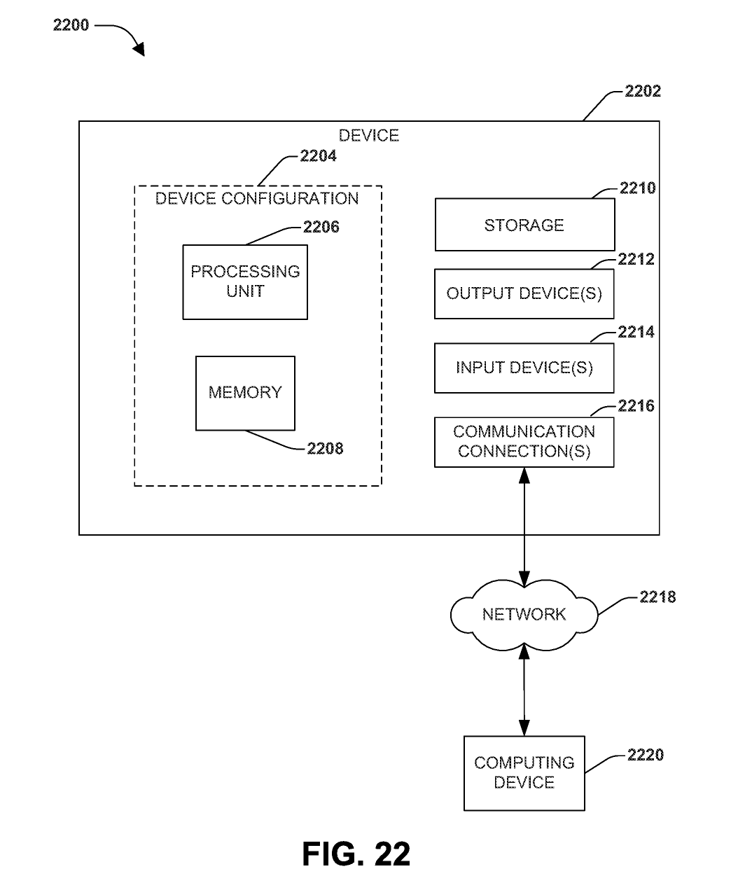

FIG. 22 and the following discussion provide a brief, general description of a suitable computing environment to implement embodiments of one or more of the provisions set forth herein. The operating environment of FIG. 22 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 22 illustrates an example of a system 2200 comprising a computing device 2202 configured to implement one or more embodiments provided herein. In one configuration, computing device 2202 includes at least one processing unit 2206 and memory 2208. Depending on the exact configuration and type of computing device, memory 2208 may be volatile (such as RAM, for example), non-volatile (such as ROM, flash memory, etc., for example) or some combination of the two. This configuration is illustrated in FIG. 22 by dashed line 2204.

In other embodiments, device 2202 may include additional features and/or functionality. For example, device 2202 may also include additional storage (e.g., removable and/or non-removable) including, but not limited to, magnetic storage, optical storage, and the like. Such additional storage is illustrated in FIG. 22 by storage 2210. In one embodiment, computer readable instructions to implement one or more embodiments provided herein may be in storage 2210. Storage 2210 may also store other computer readable instructions to implement an operating system, an application program, and the like. Computer readable instructions may be loaded in memory 2208 for execution by processing unit 2206, for example.

The term “computer readable media” as used herein includes computer storage media. Computer storage media includes volatile and nonvolatile, removable and non-removable media implemented in any method or technology for storage of information such as computer readable instructions or other data. Memory 2208 and storage 2210 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 2202. Any such computer storage media may be part of device 2202.

Device 2202 may also include communication connection(s) 2216 that allows device 2202 to communicate with other devices. Communication connection(s) 2216 may include, but is not limited to, a modem, a Network Interface Card (NIC), an integrated network interface, a radio frequency transmitter/receiver, an infrared port, a USB connection, or other interfaces for connecting computing device 2202 to other computing devices. Communication connection(s) 2216 may include a wired connection or a wireless connection. Communication connection(s) 2216 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 2202 may include input device(s) 2214 such as keyboard, mouse, pen, voice input device, touch input device, infrared cameras, video input devices, and/or any other input device. Output device(s) 2212 such as one or more displays, speakers, printers, and/or any other output device may also be included in device 2202. Input device(s) 2214 and output device(s) 2212 may be connected to device 2202 via a wired connection, wireless connection, or any combination thereof. In one embodiment, an input device or an output device from another computing device may be used as input device(s) 2214 or output device(s) 2212 for computing device 2202.

Components of computing device 2202 may be connected by various interconnects, such as a bus. Such interconnects may include a Peripheral Component Interconnect (PCI), such as PCI Express, a Universal Serial Bus (USB), Firewire (IEEE 1394), an optical bus structure, and the like. In another embodiment, components of computing device 2202 may be interconnected by a network. For example, memory 2208 may be comprised of multiple physical memory units located in different physical locations interconnected by a network.

Those skilled in the art will realize that storage devices utilized to store computer readable instructions may be distributed across a network. For example, a computing device 2220 accessible via network 2218 may store computer readable instructions to implement one or more embodiments provided herein. Computing device 2202 may access computing device 2220 and download a part or all of the computer readable instructions for execution. Alternatively, computing device 2202 may download pieces of the computer readable instructions, as needed, or some instructions may be executed at computing device 2202 and some at computing device 2220.

### G. Usage of Terms

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. One or more components may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Any aspect or design described herein as an “example” is not necessarily to be construed as advantageous over other aspects or designs. Rather, use of the word “example” is intended to present one possible aspect and/or implementation that may pertain to the techniques presented herein. Such examples are not necessary for such techniques or intended to be limiting. Various embodiments of such techniques may include such an example, alone or in combination with other features, and/or may vary and/or omit the illustrated example.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated example implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of presenting a website to a user, the method involving a device having a processor and comprising:
executing, by the processor, instructions that cause the device to:
evaluate the website to identify a set of content elements;
assemble the content elements into a conversational representation of the website, wherein the conversational representation comprises an organization of conversation pairs respectively comprising:
a conversational inquiry, and
a conversational response to the conversational inquiry that involves at least one of the content elements of the website; and
provide a conversational interaction between the user and the website by:
receiving a conversational inquiry;
selecting the conversation pair in the conversational representation that comprises the conversational inquiry; and
presenting the conversational response of the conversation pair to the user.

2. The method of claim 1, wherein assembling the conversational representation further comprises:
grouping the content elements into at least two content element groups; and
for respective content element groups, assembling a conversational representation of the content elements in the content element group.

3. The method of claim 1, wherein assembling the conversational representation further comprises:
identifying a set of actions that the user may perform over the website; and
for respective actions:
identifying a subset of the content elements that are involved in the action; and
assembling a conversational representation of the action with the subset of the content elements.

4. The method of claim 3, wherein assembling the conversational representation further comprises:
estimating frequencies with which users of the website perform the respective actions; and
organizing the conversational representation according to the frequencies of the respective actions.

5. The method of claim 1, wherein assembling the conversational representation further comprises: including, in the conversational representation, an index of conversational interactions for the website.

6. The method of claim 1, wherein assembling the conversational representation further comprises:
selecting an interaction style for the website from an interaction style set comprising:
a narrative interaction in which the content elements are presented to the user as a narrative stream;
a conversational interaction in which options for interacting with the website are presented to the user, and an option selected by the user results in a presentation of a subset of content elements that are related to the selected option; and
a query interaction in which a request initiated by the user results in a presentation of a subset of content items that are related to the request; and
assembling the conversational representation according to the selected interaction style.

7. The method of claim 1, wherein:
a selected user may interact with the website in at least two interaction contexts; and
assembling the conversational representation further comprises: assembling, for the website, at least two conversational representations that are respectively associated with an interaction style and selected for presentation to the selected user in a particular interaction context.

8. The method of claim 1, wherein:
the user may interact with the website in at least two roles; and
assembling the conversational representation further comprises: assembling, for the website, at least two conversational representations that are respectively selected for presentation while the user is in a particular role.

9. The method of claim 1, wherein:
a content element of the website further comprises a visual content element; and
assembling the conversational representation further comprises: including in the conversational representation the visual content element of the website that supplements a conversational interaction.

10. The method of claim 1, wherein:
at least one content element of the website further comprises a specialized content type that involves a specialized content handler; and
assembling the conversational representation further comprises: including, in the conversational representation, a reference to the specialized content handler to be invoked to handle the specialized content type during a conversational interaction.

11. A method of presenting a website to a user, the method involving a server having a processor and comprising:
executing, by the processor, instructions that cause the server to:
evaluate the website to identify a set of content elements;
assemble the content elements into a conversational representation of the website, wherein the conversational representation comprises an organization of conversation pairs respectively comprising:
a conversational inquiry, and
a conversational response to the conversational inquiry that involves at least one of the content elements of the website;
receive, from a device of the user, a request to access the website; and
transmit at least a portion of the conversational representation to the device of the user for presentation as a conversational interaction between the user and the website.

12. The method of claim 11, wherein:
the website further comprises a programmatic interface comprising a set of requests; and
assembling the conversational representation further comprises: assembling the conversational representation as a set of conversational interactions that cover the requests of the programmatic interface.

13. The method of claim 12, wherein assembling the conversational representation further comprises, for a selected request, including in the set of conversational interactions:
a conversational interaction that invokes the selected request; and
a conversational response that presents a response of the programmatic interface to an instance of the selected request.

14. The method of claim 11, wherein assembling the conversational representation further comprises:
from a conversational template set, selecting a conversational template for the website; and
matching the content elements of the website to template slots of the conversational template.

15. The method of claim 14, wherein:
respective conversational templates of the conversational template set are associated with a website type selected from a website type set; and
selecting the conversational template for the website further comprises:
from the website type set, selecting a particular website type for the website; and
selecting the conversational template of the conversational template set that is associated with the particular website type of the website.

16. A device that presents a website to a user, comprising:
a processor, and
a memory storing instructions that, when executed by the processor, cause the device to:
evaluate the website to identify a set of content elements;
assemble the content elements into a conversational representation of the website, wherein the conversational representation comprises an organization of conversation pairs respectively comprising:
a conversational inquiry, and
a conversational response to the conversational inquiry that involves at least one of the content elements of the website; and
provide a conversational interaction between the user and the website by:
receiving a conversational inquiry;
selecting the conversation pair in the conversational representation that comprises the conversational inquiry; and
presenting the conversational response of the conversation pair to the user.

17. The device of claim 16, wherein assemble the conversational representation of the website further comprises:
monitoring interactions of users with the website to identify a set of user interactions; and
generating a set of conversational interactions that respectively correspond to a selected interaction.

18. The device of claim 17, wherein generating a conversational interaction further comprises:
selecting, for the selected user interaction, a user interaction style selected from a user interaction style set comprising:
a receiving interaction in which users passively receives the content elements of the website,
a browsing interaction in which users browse the content elements of the website, and
a searching interaction in which users submit a search query to the website; and
generating the conversational interaction further comprises: generating the conversational interaction of an interaction style that corresponds to the user interaction style of the user interaction.

19. The device of claim 19, wherein generating the conversational interaction further comprises: excluding, from the conversational representation, a selected content element for which a conversational presentation is unavailable.

20. The device of claim 16, wherein generating the conversational interaction further comprises:
generating a conversational representation model that is trained by comparing the content elements of a training website with a user-generated conversational representation of the training website; and
applying the conversational representation model to the website.

21. The device of claim 16, wherein:
a selected conversational inquiry is associated with a second conversational representation of a second website; and
executing the instructions further causes the device to, responsive to receiving the selected conversational inquiry from the user, transition the conversational interaction to the second conversational representation of the second website.

22. The device of claim 16, wherein:
the device further has access to a second conversational representation of a second website; and
executing the instructions further causes the device to:
merge at least a portion of the conversational representation of the website and at least a portion of the second conversational representation of the second website into a merged conversational representation that provides a conversational interaction spanning the first website and the second website; and
provide the conversational interaction between the user and the website, as well as the second website, using the merged conversational representation.

23. The device of claim 16, wherein providing the conversational interaction further comprises:
initially receiving, from the user, an initial conversational inquiry that does not reference the website;
determine that the initial conversational inquiry is topically related to the website; and
fulfill the initial conversational inquiry by initiating the conversational interaction between the user and the website using the conversational representation.

24. The device of claim 16, wherein:
executing the instructions further causes the device to:
store, in the memory, an action set of actions that are respectively invokable over a selected website, wherein respective actions are associated with at least one associated conversation pair of an associated conversational representation of the selected website; and
associate at least one conversation pair of the conversational representation of the website with an action in the action set; and
providing the conversational interaction further comprises:
receiving, from the user, an initial conversational inquiry to perform the action;
identifying, in the action set, a selected conversation pair of the conversational representation of the website that is associated with the action; and
initiating the conversational interaction between the user and the website using the conversational representation.

25. The device of claim 24, wherein:
the initial conversational inquiry further specifies a set of actions; and
receiving the initial conversational inquiry further comprises:
assembling a workflow of actions that together satisfy the initial conversational inquiry; and
initiating conversational interactions for the respective actions the workflow.
